(19) United States
(12) Patent Application Publication
(10) Pub. No.: US 2026/0289277 A1
(43) Pub. Date: Sep. 24, 2026

(54) SYSTEM

(71) Applicant: SoftBank Group Corp., Tokyo (JP)

(72) Inventor: Yuki SHINOTSUKA, Tokyo (JP)

(73) Assignee: SoftBank Group Corp., Tokyo (JP)

(21) Appl. No.: 19/568,792

(22) Filed: Mar. 17, 2026

(30) Foreign Application Priority Data
Mar. 19, 2025 (JP) 2025-045185

(51) Int. Cl. G06N 3/0475; G06F 40/295; G06F 40/40; G06V 10/764; G06V 40/16; G10L 25/63

(52) U.S. Cl. CPC G06N 3/0475; G06V 10/764; G06V 40/172; G06V 40/174; G10L 25/63; G06F 40/295; G06F 40/40

(57) ABSTRACT

A system includes a processor that is configured to analyze voice data and image data of a user to recognize an emotion of the user, generate a prompt that instructs a generative AI model to determine an appropriate clothing based on the recognized emotion, and adjust the prompt to instruct the generative AI model to optimize a clothing suggestion based on acquired schedule data.

### CROSS-REFERENCE TO RELATED APPLICATION

This application is based on and claims priority under 35 USC 119 from Japanese Patent Application No. 2025-045185 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional clothing recommendation systems typically rely only on general weather information, static user profiles, or simple preference settings, and therefore cannot adequately reflect a user's current emotional state or the contextual details of the user's daily schedule. As a result, the recommended clothing may not match the user's mood, may fail to provide psychological comfort, and may not be sufficiently optimized for upcoming activities such as business meetings, outdoor events, or social occasions. In addition, existing systems do not effectively utilize generative AI models through appropriately structured prompts, and thus cannot fully exploit the capability of such models to generate nuanced and personalized clothing proposals. Consequently, there is a need for a system that can automatically recognize a user's emotion from multimodal data such as voice and images, generate prompts that cause a generative AI model to determine clothing suited to that emotion, and further adjust those prompts based on schedule data so that the final clothing recommendation is both emotionally appropriate and schedule-optimized.

### SUMMARY

To solve the above-described problems, an embodiment of the present invention provides a system comprising a processor, wherein the processor is configured to analyze voice data and image data of a user to recognize an emotion of the user, generate a prompt that instructs a generative AI model to determine an appropriate clothing based on the recognized emotion, and adjust the prompt to instruct the generative AI model to optimize a clothing suggestion based on acquired schedule data. In one embodiment, the processor is further configured to acquire the schedule data from an electronic calendar system with permission from the user, thereby enabling the system to consider planned events such as business meetings or outdoor activities when adjusting the prompt. In another embodiment, the processor is configured to notify the user of the determined clothing via a communication application, so that the user can conveniently receive emotionally and contextually optimized clothing recommendations on a terminal. By integrating emotion recognition, schedule-aware prompt adjustment, and generative AI-based clothing determination in this manner, the system can provide personalized clothing suggestions that more accurately reflect both the user's emotional state and the user's upcoming schedule.

The term “processor” refers to one or more hardware processing units, such as a central processing unit (CPU), a graphics processing unit (GPU), a digital signal processor (DSP), or any combination thereof, configured to execute instructions and perform arithmetic, logical, control, and input/output operations necessary to implement the functions of the system.

The term “voice data” refers to audio signals, in analog or digital form, that represent spoken utterances, vocal expressions, or other sound emissions of the user, and that are suitable for analysis by the processor to derive features related to emotion.

The term “image data” refers to still images, video frames, or sequences of images acquired by a camera or similar imaging device, in analog or digital form, that depict at least a part of the user, such as the user's face or body, and that are suitable for analysis by the processor to derive features related to emotion.

The term “emotion” refers to an affective state of the user, such as happiness, sadness, anger, fear, surprise, neutrality, or any other emotional category or intensity level, that is inferred or recognized by the processor based on analysis of the user's voice data and image data.

The term “generative AI model” refers to a machine-learned model, such as a large language model or a multimodal generative model, that is configured to generate text, images, or other content in response to an input prompt, and that can be instructed to determine or describe clothing suitable for the user.

The term “prompt” refers to a sequence of text, symbols, or structured data provided as input to the generative AI model, which encodes instructions, conditions, or contextual information to cause the generative AI model to generate a clothing determination or clothing suggestion.

The term “appropriate clothing” refers to one or more items of apparel or outfits that are determined by the generative AI model to be suitable for the user in view of at least the recognized emotion, and optionally in view of other contextual information such as schedule data.

The term “clothing suggestion” refers to a proposal or recommendation of specific clothing items, styles, combinations, or outfits generated by the generative AI model in response to a prompt, and intended to guide the user in selecting what to wear.

The term “schedule data” refers to information representing planned or scheduled events, appointments, tasks, or activities of the user, including at least date, time, and optionally location or event type, which is used by the processor to optimize the clothing suggestion.

The term “electronic calendar system” refers to a software or cloud-based service that stores and manages schedule data for the user, such as a calendar application or web service, and that provides an interface or application programming interface (API) through which the processor can acquire the schedule data with permission from the user.

The term “communication application” refers to a software application or service, such as a messenger app, chat app, or similar communication platform, that is capable of transmitting messages or notifications over a network to a terminal associated with the user.

The term “notify the user” refers to causing information about the determined clothing or clothing suggestion to be delivered, displayed, or otherwise presented to the user via the communication application on a terminal such as a smartphone, tablet, or personal computer.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

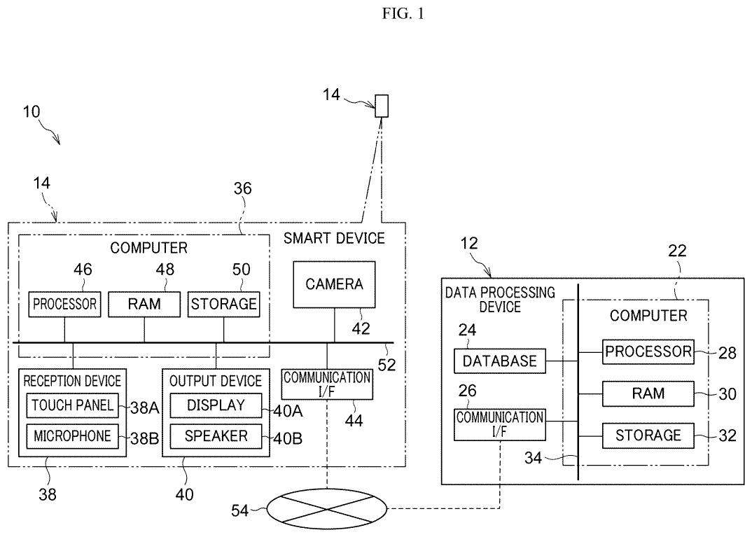

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

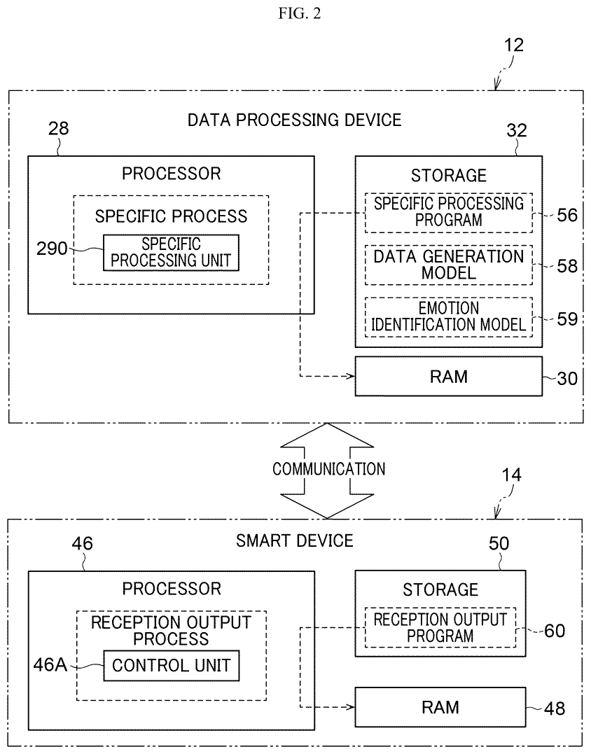

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented clothing recommendation systems typically apply fixed rules or simple mappings from temperature and calendar entries to suggested outfits. Such systems suffer from several technical limitations. First, the underlying processing pipeline often treats heterogeneous input data streams—such as weather data, user schedule data, and user preference data—as independent sources, without a unified representation of “user state” and “environmental context.” As a result, the processor performs redundant and inconsistent computations across separate modules, leading to inefficient resource usage and poor scalability when data volume or user count increases. Second, conventional systems usually generate static recommendation messages directly from rule-based logic on the server side, without a structured intermediate representation that can be effectively exploited by advanced natural language generation models. In such architectures, prompt sentences submitted to generative AI models are ad hoc and manually crafted, making it difficult for the processor to systematically incorporate fine-grained environmental conditions, activity classifications, and past user feedback. This prevents the system from leveraging generative AI models as a reusable, general-purpose natural language layer tightly integrated with the underlying decision logic, and thus reduces the quality, consistency, and adaptability of the generated recommendations.

Third, existing approaches typically do not close the feedback loop in a technically meaningful way. User feedback, if collected at all, is often stored in a loosely coupled manner, not structurally associated with the exact environmental conditions, activity information, and internal decision outputs (such as candidate clothing sets) that produced the displayed recommendation. Without such structured association, the processor cannot effectively use the feedback to update rule parameters or decision thresholds, and cannot automatically adjust prompt sentences for future calls to generative AI models. Consequently, the system remains largely static, requires manual tuning, and cannot improve its performance over time based on actual user interactions.

Fourth, the absence of a unified, learning-oriented architecture for (i) recognizing a user state from multiple types of input data, (ii) generating intermediate candidate clothing data on a component level, (iii) constructing structured prompt sentences for a generative AI model, and (iv) updating internal parameters based on user feedback, leads to a fragmented system design. This fragmentation increases processing latency, complicates maintenance, and limits portability across different server and terminal configurations. It also hinders reproducibility and traceability, because there is no consistent way to reconstruct how specific input conditions and internal parameters produced a given recommendation and prompt.

Accordingly, there is a need for an improved computer-implemented system and server-side processing architecture that (1) integrates weather information, schedule data, user preference data, and feedback data into a coherent representation of user state and environmental conditions, (2) systematically generates and refines candidate clothing data at the level of abstract clothing components, (3) automatically constructs and adjusts structured prompt sentences for a generative AI model, and (4) continuously updates internal clothing rule information and decision parameters based on accumulated learning data. Such a system should enhance the technical efficiency, adaptability, and scalability of the processor's operations, and improve the overall quality and personalization of the clothing recommendations delivered to the user.

The specific processing by the specific processing unit 290 of the data processing device 12 in Example 1 is realized by the following means.

The present invention provides a server comprising a processor configured to analyze input data including user attribute information and environment information to recognize a user state; acquire weather information from an external information providing unit based on the recognized user state and acquired time information, and specify environmental conditions for a target day based on the weather information and the time information; acquire schedule data from a schedule management unit based on permission from a user, and classify each scheduled item included in the schedule data as activity information including an activity type classification and an indoor/outdoor classification; refer to clothing rule information defined for each of a temperature condition, a precipitation condition, and an activity type condition based on the environmental conditions and the activity information, and generate candidate clothing data for each clothing component as a higher-level clothing concept; apply user preference information and past evaluation information to the candidate clothing data, narrow down the candidate clothing data, and generate clothing determination data suitable for the user; generate a prompt sentence by structuring, as natural language text, description information including the environmental conditions, the activity information, the candidate clothing data, and the clothing determination data, and input the prompt sentence to a generative AI model to acquire an explanation text in natural language corresponding to the clothing determination data; generate notification information including the clothing determination data and the explanation text, and transmit the notification information to an information processing terminal having a communication function so that the information processing terminal presents the notification information to the user; acquire evaluation information and comment information from the user with respect to the notification information, and store, as learning data, the evaluation information and the comment information in association with the environmental conditions, the activity information, and the clothing determination data; and update at least one of the clothing rule information and a determination parameter for generating the clothing determination data based on the learning data, and automatically adjust the candidate clothing data and the prompt sentence generated thereafter. This enables an integrated, computer-implemented processing pipeline in which the processor (i) unifies heterogeneous input data into a coherent representation of user state and environmental context, (ii) generates and refines abstract candidate clothing data on a component level, (iii) automatically constructs and adapts structured prompt sentences for interaction with a generative AI model, and (iv) continuously improves internal rule information and decision parameters based on structured feedback, thereby enhancing the technical performance, efficiency, and personalization capability of the clothing recommendation system.

The term “processor” refers to a hardware or virtual computing element, such as a central processing unit or a processing core executed by a computing device, that executes instructions to perform data acquisition, analysis, decision making, and communication operations described in the present specification.

The term “user attribute information” refers to data representing characteristics of a user, including at least one of demographic characteristics, clothing preference characteristics, sensitivity to environmental conditions, and style constraints that affect clothing selection.

The term “environment information” refers to data related to conditions surrounding the user, including at least one of geographic location information, time information, season information, and context information indicating an expected usage environment.

The term “user state” refers to a logical representation of the user's situation derived from user attribute information and environment information, including at least one of comfort preference, formality requirement, and activity readiness at a given time.

The term “time information” refers to data representing a temporal context, including at least one of date, time of day, and time range for which clothing is to be recommended.

The term “external information providing unit” refers to a computing resource or service that supplies environment-related data, including at least one of a weather information service, a location information service, and a general-purpose data provision service accessible via a communication network.

The term “weather information” refers to data representing meteorological conditions for a target region and time, including at least one of temperature, humidity, precipitation probability, precipitation amount, wind speed, and weather condition category.

The term “environmental conditions” refers to a set of parameters that characterize the external environment of the user for a target period, derived from weather information and time information, and including at least one of average temperature, expected maximum temperature, expected minimum temperature, presence of precipitation, and humidity level.

The term “schedule management unit” refers to a computing resource or service that stores and manages schedule data for a user, including at least one of a calendar service, an event management service, and an electronic planning service.

The term “schedule data” refers to data representing future or current activities of a user, including at least one of event start time, event end time, event location, event description, and participation requirement.

The term “activity information” refers to data derived from schedule data in which each scheduled item is classified into at least one of an activity type classification and an indoor/outdoor classification, and optionally includes additional attributes such as required formality or expected physical intensity.

The term “activity type classification” refers to a category assigned to a scheduled item, including at least one of work-related activity, formal meeting, casual gathering, travel, outdoor leisure, and indoor stay.

The term “indoor/outdoor classification” refers to a classification indicating whether a scheduled activity is primarily performed in an indoor environment, in an outdoor environment, or in a mixed environment.

The term “clothing rule information” refers to data defining associations between environmental conditions, activity information, and clothing recommendations, including at least one of thresholds, conditions, and mapping rules specifying which clothing components are suitable under given temperature, precipitation, and activity type conditions.

The term “temperature condition” refers to a condition or range defined over one or more elements of weather information related to temperature, such as average temperature, maximum temperature, or minimum temperature, used to select or filter clothing recommendations.

The term “precipitation condition” refers to a condition or range defined over one or more elements of weather information related to precipitation, such as precipitation probability or expected precipitation amount, used to select or filter clothing recommendations.

The term “activity type condition” refers to a condition defined based on the activity type classification and indoor/outdoor classification for scheduled items, used to select or filter clothing recommendations.

The term “clothing component” refers to an abstract element of an outfit, including at least one of an upper-body item, a lower-body item, outerwear, footwear, and an accessory, each of which may be instantiated by one or more specific garments.

The term “candidate clothing data” refers to structured data representing one or more sets of possible clothing components and their attributes that satisfy clothing rule information for given environmental conditions and activity information before final user-specific refinement.

The term “user preference information” refers to data indicating the user's likes, dislikes, and constraints regarding clothing, including at least one of preferred formality level, color preference, material preference, temperature comfort range, and prohibited garment types.

The term “past evaluation information” refers to data representing historical user responses to previously presented clothing recommendations, including at least one of numeric ratings, acceptance indicators, and qualitative assessments.

The term “clothing determination data” refers to structured data representing a specific clothing recommendation selected for presentation to the user, including at least one set of clothing components and associated attributes deemed suitable for the user under current environmental conditions and activity information.

The term “prompt sentence” refers to a structured natural language text generated by the processor, including description information such as environmental conditions, activity information, candidate clothing data, and clothing determination data, and used as an input sequence to a generative AI model.

The term “generative AI model” refers to a machine-learned model configured to generate natural language text in response to an input, including at least one of a large language model and a sequence-to-sequence model trained on text data.

The term “explanation text” refers to natural language text generated by the generative AI model based on the prompt sentence, describing or justifying the clothing determination data in human-readable form.

The term “notification information” refers to data that combines the clothing determination data with accompanying explanation text and optional metadata, and is formatted for transmission to and presentation by an information processing terminal.

The term “information processing terminal” refers to an electronic device having a communication function and user interface capability, including at least one of a smartphone, a tablet device, a wearable device, and a general-purpose computing device.

The term “evaluation information” refers to feedback data provided by the user in response to notification information, including at least one of a rating value, a selection result, and an acceptance or rejection indicator regarding the recommended clothing.

The term “comment information” refers to free-form or semi-structured text provided by the user relating to the notification information, including at least one of subjective impressions, comfort statements, and improvement requests.

The term “learning data” refers to data stored by associating evaluation information and comment information with corresponding environmental conditions, activity information, and clothing determination data, and used as a basis for updating clothing rule information or determination parameters.

The term “determination parameter” refers to a parameter used by the processor in algorithms for generating candidate clothing data or clothing determination data, including at least one of threshold values, weights, coefficients, and model parameters that influence decision logic.

In one embodiment, a server, a terminal, and a user cooperate to implement a clothing recommendation system based on environmental conditions, user activities, and user preferences. The server executes software modules on a hardware platform such as a multi-core processor, memory, a non-volatile storage device, and a network interface. The server runs an operating system such as a general-purpose server operating system, and executes application programs implemented, for example, in a high-level programming language such as Python. The server uses software libraries such as an HTTP client library, a JSON parsing library, a relational database management system, and a machine learning framework. The terminal executes a mobile application on a computing device such as a smartphone or a tablet computer, and provides a user interface, sensors, and network connectivity.

The server implements an input data acquisition module that obtains heterogeneous external and internal data used to determine clothing recommendations. The server acquires weather information by sending an HTTP request to a weather information providing service through the network interface. The server includes parameters such as a location identifier and an API key in the request, and receives weather information in JSON format. The server parses the JSON payload using a JSON parser, and stores normalized records in a weather table in a relational database such as a structured query language database server. Each record includes at least a timestamp, location, temperature, humidity, precipitation probability, and a weather condition code.

The terminal acquires schedule data by interacting with a schedule management service through a secure authorization protocol. The terminal executes an authentication sequence, obtains an access token, and downloads schedule entries in JSON format. The terminal parses the schedule data and sends selected fields such as start time, end time, title, location, and organizer to the server through an encrypted communication channel. The server receives the schedule data, validates the data format, and inserts schedule records into a schedule table in the database, associating each record with a user identifier.

The user provides user attribute information and user preference information through the terminal. The user operates graphical controls such as sliders, switches, and selection lists to specify comfort levels, style preferences, and constraints. For example, the user indicates that the user tends to feel hot, prefers business casual style, avoids certain materials, and allows short-sleeve tops only in informal contexts. The terminal stores the user preference information in secure local storage, and transmits the information to the server. The server records the user attribute information and user preference information in user profile tables and uses relational keys to link them to schedule records.

The server constructs a user state representation by integrating user attribute information, current or future time information, and environment information. The server maintains an internal data structure, such as a feature vector, that encodes user-specific comfort ranges, formality requirements, and sensitivity to temperature. The server also aggregates weather information for the relevant time range corresponding to the schedule entries. The server therefore holds a unified representation combining user state and environmental conditions for the target period.

The server performs activity classification by transforming schedule records into activity information. The server executes text analysis on event titles and descriptions to detect keywords associated with activity types such as business meetings, formal ceremonies, casual gatherings, commuting, and outdoor leisure. The server also evaluates location fields and, when available, uses geolocation metadata to infer whether each activity is likely to occur indoors or outdoors. The server assigns activity type labels and indoor/outdoor labels to each schedule entry. The server stores the resulting activity information in an activity table, linked to the original schedule data. This structured activity information reduces ambiguity and supports efficient querying when generating clothing recommendations.

The server maintains clothing rule information that defines mappings between environmental conditions, activity information, and clothing components. The server stores this clothing rule information in a rules table or a configuration file. Each rule includes conditions on temperature ranges, precipitation thresholds, activity type categories, and indoor/outdoor attributes, and specifies one or more recommended clothing components such as upper-body items, lower-body items, outerwear, footwear, and accessories. The server also stores rule weights or priorities, which are later used in conflict resolution and ranking.

The server generates candidate clothing data by applying clothing rule information to the environmental conditions and activity information. The server queries the database or configuration store to retrieve rules whose conditions overlap with the current environmental conditions and the classified activities. The server creates candidate sets of clothing components by combining rule outputs in a way that covers all relevant activities during the target period. The server may represent each candidate as a data structure containing identifiers for clothing components, expected formality levels, thermal insulation values, and other attributes. The server discards combinations that violate user preference information or physical constraints, such as incompatible outerwear layering.

The server refines the candidate clothing data using user preference information and past evaluation information. The server retrieves historical evaluation records associated with similar environmental conditions and activity profiles. The server computes similarity measures between the current condition vector and historical condition vectors. The server uses these similarity scores and past ratings to adjust the weights of candidate outfits. For instance, if the user consistently rates heavy jackets poorly in certain temperature ranges, the server reduces the selection probability for heavy jackets under similar conditions. The server then selects clothing determination data by ranking candidates according to a composite score derived from rule weights, user preferences, and past evaluation information.

The server constructs a prompt sentence for a generative AI model based on the determined clothing data and contextual information. The server uses a template-based generation module that receives parameters representing environmental conditions, activity information, candidate clothing data, and finalized clothing determination data. The server fills placeholders in a natural language template to produce a structured prompt sentence. An example of such a prompt sentence is:

“Today's average temperature in Tokyo is 30° C. with high humidity and no expected rain. The user's schedule includes: (1) a 9:00-11:00 indoor business meeting at an office, (2) a 12:00-13:00 outdoor lunch, and (3) a 19:00-21:00 informal dinner at a casual restaurant. The candidate clothing items are a short-sleeve dress shirt, a lightweight blazer, breathable slacks, and leather shoes. The user prefers business casual style and tends to feel hot in warm weather. Based on this information, propose a concrete outfit and briefly explain why it is suitable. Keep the answer within 5 sentences.”

The server inputs the prompt sentence into a generative AI model that implements a neural network architecture such as a transformer-based language model. The generative AI model comprises multiple layers of attention mechanisms, feed-forward sub-layers, and normalization units. The model uses token embeddings and positional encodings to convert the prompt sentence into a sequence of numerical vectors. The model processes the sequence using multi-head self-attention and outputs probability distributions over vocabulary tokens. The model is trained beforehand using large-scale text data and fine-tuned, in some implementations, using task-specific examples relating to recommendation explanations. The server interacts with the generative AI model by sending the prompt sentence through an API that accepts textual input and returns generated text. The server specifies parameters such as maximum output length, sampling strategy, and temperature for controlling randomness. The server receives an explanation text that describes the recommended outfit and the reasons for its suitability. The server parses the returned text and stores it together with the corresponding prompt sentence and clothing determination data. This structured association permits later analysis of how prompt sentence variations influence explanation content.

The server generates notification information by combining the clothing determination data and the explanation text. The server formats this information as a data structure that includes a list of clothing components, textual descriptions, and any auxiliary hints such as preparation tips. The server transmits the notification information to the terminal over a communication network.

The terminal receives the notification information and presents it to the user in an interactive user interface. The terminal displays the selected clothing components with clear labels and icons, and shows the explanation text produced by the generative AI model. The user can scroll through the explanation, examine individual items, and indicate whether the user intends to follow the recommendation. The terminal may display options such as “Accept,” “Modify,” or “Reject,” enabling the user to provide direct feedback.

The user provides evaluation information and comment information through the terminal. The user selects a satisfaction score or assessment and may enter free-form text describing how well the recommendation matched actual experiences. The terminal packages this feedback as structured data and sends it to the server.

The server stores evaluation information and comment information as learning data associated with environmental conditions, activity information, and clothing determination data that were in effect when the recommendation was generated. The server uses this learning data in a model update process that may be performed periodically or upon accumulation of a sufficient number of feedback instances. The server computes features for each recommendation-feedback pair, including temperature range, humidity, activity mix, clothing component types, and user profile attributes. The server then applies a machine learning algorithm, for example a gradient-based optimization method, to update determination parameters such as rule thresholds, component weights, and similarity metrics. The server may also adjust prompt sentence structures, for example by emphasizing factors that correlate with higher user satisfaction.

The server implements the generative AI model interaction in a way that improves computer technology rather than merely automating human judgment. The server constructs intermediate representations such as feature vectors, candidate clothing sets, and structured prompts that are optimized for machine processing. The server reduces communication load by transmitting compressed representations of weather and schedule data between modules, and only sending summarized context and final determination data to the generative AI model. This reduces the size of prompt sentences and accelerates inference. The server also leverages database indexing and caching strategies so that repeated queries for similar conditions can be served from cache, reducing database access latency and improving throughput.

The server improves overall processing precision by using structured, rule-driven candidate generation combined with feedback-driven parameter adjustment instead of relying solely on heuristic or manually tuned thresholds. The server's use of a transformer-based generative AI model with carefully constructed prompt sentences produces explanation texts that are more consistent and context-aware than simple rule-generated statements. This consistency reduces user confusion and results in more accurate interpretation of recommendations, which in turn yields more reliable feedback for the learning loop.

The server's learning loop enhances computational efficiency by focusing parameter updates on those rules and conditions that exhibit high sensitivity to user feedback. For instance, the server may compute gradients or importance scores that identify temperature thresholds or activity-type mappings contributing most to dissatisfaction. The server then modifies only those parameters, rather than retraining the entire system, thereby reducing computation cost and minimizing downtime. This targeted update mechanism exemplifies an improvement to computer-based decision systems through more efficient parameter management.

The server's architecture differs from a mere business process automation because it defines specific data structures, algorithms, and neural network interactions that are optimized for technical performance. The server normalizes heterogeneous data into structured forms, uses non-conventional sequences of rule application and feedback-incorporating ranking, and employs a generative AI model not simply as a user-interface embellishment, but as an integrated component that receives structured prompt sentences reflecting internal decision states. This integration creates a closed-loop system that refines both decision logic and natural language output in response to measured user satisfaction, leading to improved accuracy, latency, and robustness.

In alternative embodiments, the server may run the generative AI model locally instead of via a remote service. In such cases, the server stores model parameters on local storage, loads them into memory, and executes forward propagation of the transformer network on a graphics processing unit or specialized accelerator. The server may also experiment with different neural network architectures, such as recurrent neural networks or hybrid architectures combining convolutional and attention mechanisms. The server may select an architecture that balances inference speed and explanation quality for the target deployment environment.

In other embodiments, the terminal may implement part of the activity classification or rule-based filtering locally, reducing the amount of data sent to the server and lowering communication load. The terminal may, for example, perform an initial classification of events into indoor or outdoor activities using on-device natural language processing models and then send compact labels to the server. The server, in turn, can focus on higher-level integration and generative AI model interaction, leading to better distribution of computational tasks between devices.

In still other embodiments, multiple servers may share learning data and rule updates through a synchronization mechanism. One server may aggregate anonymized feedback from many users, compute global parameter adjustments, and distribute updated clothing rule information to edge servers closer to users. This arrangement can reduce latency for inference while maintaining up-to-date decision logic across the system.

Through these embodiments, the server, the terminal, and the user jointly participate in a technically grounded architecture in which data acquisition, structured decision logic, generative AI model interaction, and feedback-driven learning are concretely implemented on specific hardware and software components. The system thereby improves computer technology by enhancing processing efficiency, recommendation precision, data management, and communication performance beyond conventional rule-based or manually tuned approaches.

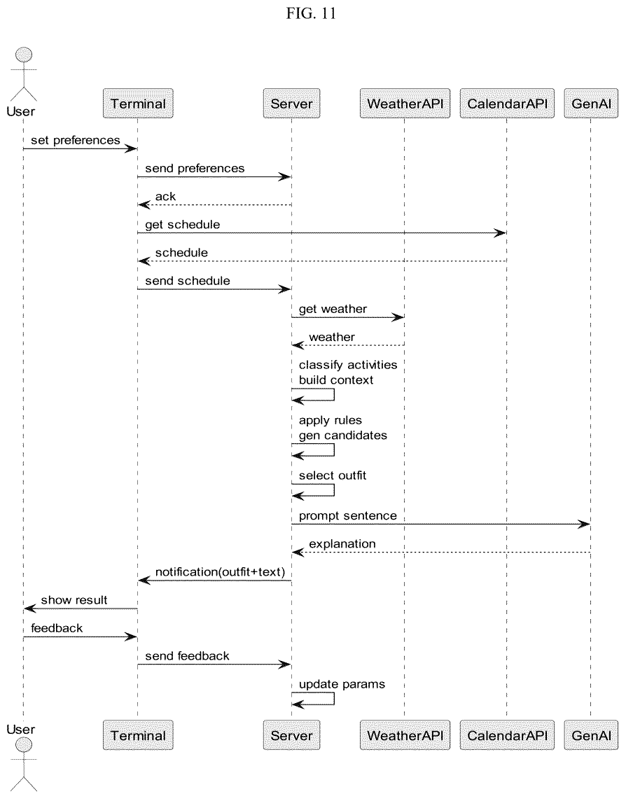

The following describes the processing flow using FIG. 11.

Step 1:

The terminal acquires user attribute information and user preference information from the user.

The terminal displays input screens that include selection lists, sliders, and text fields, and the user specifies attributes such as formality preference, temperature sensitivity, and clothing constraints.

Input: raw user inputs from the graphical user interface (e.g., selected options, numeric values, and text strings).

Processing: the terminal converts these raw inputs into a structured data object, for example a key-value map where each field (such as “formality_level” or “temperature_sensitivity”) is normalized to an internal code. The terminal validates the data types and ranges, and removes invalid or incomplete entries.

Output: structured user attribute information and user preference information, which the terminal stores locally and sends to the server via a network request.

Step 2:

The server stores the received user attribute information and user preference information in a persistent database.

The server receives a network request from the terminal, parses the request payload, and performs authentication to associate the data with a user identifier.

Input: structured user attribute and preference data, along with a user identifier and authentication tokens.

Processing: the server checks the schema of the received data against predefined database column definitions, converts values to database-compatible formats (for example, converting categorical labels to integer codes), and performs an insert or update operation in user profile tables. The server may apply hashing or encryption for sensitive fields.

Output: stored user profile records in the database, and a confirmation response returned to the terminal indicating successful registration of preferences.

Step 3:

The server acquires weather information from an external information providing unit.

The server reads configuration parameters such as geographic location and time range, constructs an HTTP request, and sends the request through its network interface to a weather information service.

Input: location identifier, time information, and an access credential such as an API key.

Processing: the server issues an HTTP GET request, receives weather data in JSON format, and parses the JSON into internal structures. The server extracts fields such as temperature, humidity, precipitation probability, and weather condition codes, and normalizes units if necessary (for example, Celsius vs. Fahrenheit).

Output: normalized weather records that the server stores in a weather data table in the database and passes to subsequent modules as environmental input.

Step 4:

The terminal acquires schedule data from a schedule management unit and forwards it to the server.

The terminal initiates an authorization flow, obtains an access token, and sends an API request to the schedule management service to retrieve schedule entries for a target period.

Input: user authorization credentials, access token, and query parameters such as date range.

Processing: the terminal sends an HTTPS request, receives schedule data in JSON format, and parses event fields such as start time, end time, title, description, and location. The terminal may filter out events that do not pertain to clothing (for example, all-day reminders). The terminal then packages selected event fields into a compact JSON payload and sends the payload to the server.

Output: structured schedule data transmitted to the server, including a list of events with time and basic descriptive information.

Step 5:

The server classifies schedule entries into activity information including activity type classification and indoor/outdoor classification.

The server retrieves the schedule data from the received payload or from a schedule table in the database and applies classification logic.

Input: schedule entries containing event times, titles, descriptions, and locations.

Processing: the server performs text analysis, such as keyword matching or simple natural language processing, on the event titles and descriptions to determine activity categories (for example, “business_meeting,” “casual_gathering,” “outdoor_leisure”). The server evaluates location strings and, where available, geolocation tags or known place types to infer indoor or outdoor status. The server assigns classification codes to each event, and stores the result in an activity table linked to the original schedule entries.

Output: activity information records, each record including an activity type classification, an indoor/outdoor classification, and a time range.

Step 6:

The server constructs a user state and environmental conditions representation based on user profile data, weather data, and activity information.

The server retrieves the user attribute information, user preference information, weather records for the relevant time period, and activity information for the user.

Input: stored user profile records, weather records (temperature, humidity, precipitation), and activity information records.

Processing: the server aggregates weather parameters over the time ranges covered by the activities (for example, computing average, maximum, and minimum temperature). The server combines these aggregated weather features with user profile features (such as comfort temperature range and formality level) into a feature vector or a structured object. The server includes, in this representation, information about the distribution of indoor vs. outdoor activities and the expected duration of each activity type.

Output: a unified user state and environmental conditions object that describes, for a target day, the expected external conditions and the user's relevant characteristics.

Step 7:

The server generates candidate clothing data by applying clothing rule information to the user state and environmental conditions.

The server queries a rules repository that defines conditions under which specific clothing components are recommended.

Input: user state and environmental conditions object, activity information, and clothing rule information.

Processing: the server evaluates each rule's conditions against the environmental conditions and activity attributes, for example testing whether the average temperature exceeds a threshold, whether precipitation probability exceeds a limit, or whether certain activity types (such as formal meetings) are present. For rules whose conditions are satisfied, the server collects associated clothing components (for example, upper-body item type, lower-body item type, outerwear type). The server then combines these components into candidate outfits that cover the full set of activities, while checking compatibility constraints (such as not pairing mutually exclusive outerwear items).

Output: candidate clothing data, represented as a set of candidate outfits, each outfit containing one or more clothing components and associated metadata (such as formality level and expected thermal comfort).

Step 8:

The server refines the candidate clothing data using user preference information and past evaluation information to generate clothing determination data.

The server retrieves historical evaluation data and user preference constraints from the database.

Input: candidate clothing data, user preference information, and past evaluation information including ratings and comments.

Processing: the server filters out any candidate outfits that violate user constraints (for example, prohibited garment types). The server computes a score for each remaining candidate using a scoring function that combines rule-based priority, match with user preferences, and historical satisfaction scores under similar conditions. To compute similarity, the server compares the current feature vector of environmental and activity conditions with stored feature vectors, using a similarity metric such as a weighted distance. The server ranks the candidates according to the scores and selects one or more top-ranked outfits as the clothing determination data.

Output: clothing determination data, representing one or more selected outfits tailored to the user's preferences and expected conditions.

Step 9:

The server constructs a prompt sentence for a generative AI model based on the clothing determination data and contextual information.

The server uses a template or formatting module to convert structured data into natural language text.

Input: environmental conditions, activity information, candidate clothing data, clothing determination data, and user preference highlights.

Processing: the server assembles a coherent description by inserting parameter values (for example, temperature values, activity descriptions, and clothing item names) into predefined sentence templates. The server ensures that the prompt includes both a detailed context and an instruction for the generative AI model. For example, the server generates the following prompt sentence:

“Today's average temperature in Tokyo is 30° C. with high humidity and no expected rain. The user's schedule includes: (1) a 9:00-11:00 indoor business meeting at an office, (2) a 12:00-13:00 outdoor lunch, and (3) a 19:00-21:00 informal dinner at a casual restaurant. The candidate clothing items are a short-sleeve dress shirt, a lightweight blazer, breathable slacks, and leather shoes. The user prefers business casual style and tends to feel hot in warm weather. Based on this information, propose a concrete outfit and briefly explain why it is suitable. Keep the answer within 5 sentences.”

Output: a complete prompt sentence in natural language, ready to be submitted to the generative AI model.

Step 10:

The server interacts with the generative AI model to obtain an explanation text corresponding to the clothing determination data.

The server transmits the prompt sentence to the generative AI model through an application programming interface.

Input: the prompt sentence generated in Step 9 and model control parameters such as maximum output length and sampling strategy.

Processing: the server encodes the prompt sentence as text in an API request, sends it over the network, and receives a response containing generated natural language text. Internally, the generative AI model applies a neural network architecture (for example, a transformer network) that converts the input tokens into vector representations, performs attention-based computations across layers, and outputs a sequence of tokens representing the explanation. The server extracts the generated explanation text from the response, sanitizes it if necessary (for example, removing unsupported characters), and links it to the corresponding clothing determination data.

Output: explanation text that describes the recommended outfit and the reasons for its suitability.

Step 11:

The server generates notification information and transmits it to the terminal for presentation to the user.

The server packages the clothing determination data and the explanation text into a single response object.

Input: clothing determination data and explanation text obtained from the generative AI model.

Processing: the server formats the data into a notification structure that includes a list of clothing components, descriptive names, and the explanation text. The server may add identifiers and timestamps to support logging and later feedback association. The server then sends the notification structure as a response to a request from the terminal or as a push message through a messaging channel.

Output: notification information delivered to the terminal, comprising both structured outfit data and natural language explanation.

Step 12:

The terminal displays the notification information and collects feedback from the user.

The terminal receives the notification from the server and updates the user interface accordingly.

Input: notification information including clothing determination data and explanation text.

Processing: the terminal parses the received data, displays the clothing items with readable labels and icons, and shows the explanation text in a text area. The terminal provides controls such as buttons or sliders for the user to submit a rating and a comment. When the user interacts with these controls, the terminal records evaluation information (such as a score) and comment information (such as free-form text), packages them into a structured payload, and prepares them for transmission to the server.

Output: user evaluation information and comment information ready to be sent to the server as feedback.

Step 13:

The server stores user feedback as learning data associated with the conditions and decisions that produced the recommendation.

The server receives the feedback payload from the terminal and links it to the originating recommendation.

Input: evaluation information, comment information, and identifiers referencing the notification, the user, and the time of recommendation.

Processing: the server validates the feedback fields, ensuring rating values fall within allowed ranges and comment text lengths are within limits. The server reads the associated environmental conditions, activity information, and clothing determination data from the database using the identifiers. The server then creates a learning data record that bundles the feedback with the contextual features and decision outputs, and inserts this record into a dedicated learning data table.

Output: stored learning data entries that can be used for later parameter updates and algorithm refinement.

Step 14:

The server updates clothing rule information and determination parameters based on accumulated learning data.

The server periodically runs a learning process that reads learning data from the database.

Input: a set of learning data records, including past environmental conditions, activity information, clothing determination data, and corresponding evaluation information and comment information.

Processing: the server extracts numerical features (such as temperature, humidity, activity categories, and clothing component types) and target variables (such as satisfaction scores). The server applies a learning algorithm, which may involve computing loss values (for example, mean squared error between predicted satisfaction and actual satisfaction) and adjusting parameters via gradient-based updates. The server updates rule thresholds (such as comfort temperature ranges for specific garments) and weight coefficients used in scoring candidate outfits. The server may also adjust prompt construction parameters, such as deciding which contextual factors to emphasize based on their observed impact on satisfaction.

Output: updated clothing rule information and determination parameters, which the server uses in subsequent executions of Steps 7 through 10 to generate improved candidate clothing data, clothing determination data, and prompt sentences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional clothing recommendation systems typically rely on static rule sets or simple filtering logic that operate on limited user inputs such as manually selected preferences or generic weather summaries. Such systems are not well adapted to dynamically combine heterogeneous context data sources, including fine-grained weather forecasts, time-dependent schedule information, and in-store product availability data. As a result, conventional systems often generate recommendations that are either too generic, not aligned with the user's actual activities over time, or not practically actionable in terms of concrete purchasable items.

Moreover, existing architectures that attempt to use machine learning or generative models for recommendations frequently send only coarse prompts that lack structured context integration, leading to unstable output quality, inconsistent reasoning, and increased need for manual user trial-and-error. These systems do not provide an efficient mechanism for a processor to normalize time-varying environmental data, classify schedule information into event types and clothing requirement levels, and then automatically construct prompt sentences that guide a generative AI model in a deterministic and reproducible manner. This results in suboptimal utilization of computing resources, unnecessary network traffic, and degraded user experience.

Additionally, conventional systems do not tightly couple high-level outfit proposals with the inventory of a physical or virtual store. They lack an integrated data processing pipeline by which a processor can convert abstract clothing proposals into structured data, perform programmatic association with product data from product information management systems, and maintain an interactive feedback loop where user-provided prompt sentences can refine both the AI-generated proposal and the product mapping. Consequently, there is a need for a computer-implemented technique that improves how a processor orchestrates context acquisition, data normalization, prompt construction, generative inference, and product association, thereby improving the technical operation of the recommendation system as a whole.

The specific processing by the specific processing unit 290 of the data processing device 12 in Application Example 1 is realized by the following means.

The present invention provides a server comprising a processor configured to acquire user context information including at least location information and schedule information from a terminal apparatus; to acquire weather data from an external weather information providing apparatus on the basis of the location information and to normalize the weather data by at least time period and temperature range; to acquire the schedule information from an external schedule management apparatus and classify the schedule information into event types and clothing requirement levels; to apply a rule set that associates clothing elements with at least temperature conditions, weather conditions, and activity conditions, on the basis of the normalized weather data and the classified schedule information, and to computationally determine basic clothing candidates; to generate, on the basis of the basic clothing candidates and the user context information, a prompt sentence that instructs a generative AI model to concretize a clothing proposal and provide reasoning while describing contents of the basic clothing candidates; to execute an inquiry process to the generative AI model by using the generated prompt sentence and acquire, from the generative AI model, a clothing proposal and an explanation in natural language; to format the acquired clothing proposal and explanation as structured data and transmit the structured data to the terminal apparatus; and to acquire product data from a store product information management apparatus, generate association information that associates the clothing proposal included in the structured data with actual products on the basis of the product data and the structured data, and transmit the association information to the terminal apparatus. This enables an improved computer-implemented recommendation process in which heterogeneous context data are normalized and fused by the processor, generative AI inference is guided by deterministically constructed prompt sentences, and high-level clothing proposals are automatically linked to concrete products, thereby enhancing system efficiency, output consistency, and user interaction through an integrated, technically optimized data processing pipeline.

The term “processor” refers to any hardware logic element or combination of hardware logic elements, including but not limited to a central processing unit, a microcontroller, a digital signal processor, a graphics processing unit, or a programmable logic device, that is configured to execute instructions to perform the functions described herein.

The term “terminal apparatus” refers to any user-operable electronic apparatus having at least a communication function and a user interface, including but not limited to a mobile communication device, a portable information processing device, or a stationary information processing device, that is configured to exchange data with a server and present information to a user.

The term “user context information” refers to information that characterizes a state related to a user at a given time, including at least location information and schedule information, and optionally including preference information, permission information, or device state information, which is used by the processor to generate clothing recommendations.

The term “location information” refers to information indicative of a geographical position associated with a user or a terminal apparatus, including but not limited to latitude and longitude, area identifiers, or region codes, obtained by a positioning mechanism such as a satellite positioning system, a base station positioning system, or a network-based positioning system.

The term “schedule information” refers to time-dependent information indicating planned activities of a user, including at least start times, end times, and descriptive information of events, which is obtained from a schedule management apparatus such as an electronic calendar system.

The term “external weather information providing apparatus” refers to any external information processing apparatus or service that provides meteorological data via a communication network, including but not limited to servers of a weather information provider, and that is accessible by the processor through an application programming interface or other communication interface.

The term “weather data” refers to meteorological information obtained from the external weather information providing apparatus, including but not limited to temperature, precipitation, humidity, wind speed, and weather condition indicators and associated time information.

The term “normalize the weather data” refers to processing the weather data so as to convert or map the weather data into a unified data format or scale, including at least organizing the data by time period and by temperature range, and optionally adding or transforming attributes such as condition categories or severity levels, to facilitate subsequent computation by the processor.

The term “external schedule management apparatus” refers to any information processing apparatus or service that manages schedule information for a user, including but not limited to an electronic calendar system, a group scheduling system, or a task management system, and that provides schedule information via a communication network.

The term “event types” refers to classification categories assigned to events included in the schedule information, such as business events, casual events, outdoor activities, or exercise activities, which are used by the processor to determine appropriate clothing requirements.

The term “clothing requirement levels” refers to indicators or categories that express a degree or type of clothing formality, protection, or suitability required for an event, including but not limited to levels of formality, warmth, water resistance, or activity-appropriateness.

The term “rule set” refers to a collection of predefined logical conditions, mappings, or inference rules that associate clothing elements with environmental conditions and activity conditions, and that are applied by the processor to determine basic clothing candidates from the normalized weather data and the classified schedule information.

The term “clothing elements” refers to abstract components of an outfit, including but not limited to tops, bottoms, outerwear, footwear, and accessories, each represented by attributes such as type, formality, warmth, and weather resistance.

The term “basic clothing candidates” refers to one or more clothing elements or combinations thereof that are computationally determined by applying the rule set to the normalized weather data and the classified schedule information, prior to refinement by a generative AI model.

The term “prompt sentence” refers to a text string or structured textual instruction generated by the processor and supplied to a generative AI model, the text string including information that guides the generative AI model to produce a clothing proposal and an explanation consistent with the basic clothing candidates and the user context information.

The term “generative AI model” refers to a machine learning model, such as a neural network-based language model, that is capable of generating natural language output, or other content, in response to input text including a prompt sentence, and that is used to refine clothing proposals and provide explanatory information.

The term “inquiry process” refers to a sequence of operations executed by the processor to transmit a prompt sentence or related data to the generative AI model via a communication interface, and to receive from the generative AI model a generated response including at least a clothing proposal and an explanation in natural language.

The term “clothing proposal” refers to information representing recommended clothing items or combinations thereof for a user, the information being produced or refined by the generative AI model on the basis of the prompt sentence and including, for example, specific types of garments and their attributes.

The term “explanation in natural language” refers to textual information expressed in a human language that describes reasons or rationale for the clothing proposal generated by the generative AI model, such as relationships to weather conditions, schedule activities, or user preferences.

The term “structured data” refers to data representing the clothing proposal and the explanation in a machine-readable organized format, such as key-value pairs, records, or hierarchical objects, which allows the terminal apparatus or other components to process and display the data systematically.

The term “store product information management apparatus” refers to an information processing apparatus or system that manages data related to products available in a store, including but not limited to an inventory management system, a merchandise database, or an e-commerce backend system, and that can provide product data to the processor.

The term “product data” refers to information about products managed by the store product information management apparatus, including but not limited to product identifiers, categories, attributes, prices, sizes, colors, and availability information.

The term “association information” refers to information generated by the processor that associates elements of the clothing proposal, as represented in the structured data, with specific products represented in the product data, thereby enabling selection or presentation of concrete purchasable items corresponding to the abstract clothing recommendations.

In one embodiment, a server, a terminal, and a user cooperate to implement the invention.

The server includes at least one processor, a main memory, a non-volatile storage device, and a network interface. The server executes a server program stored in the non-volatile storage device and loaded into the main memory. The server runs on a general-purpose computing platform such as a rack-mounted information processing apparatus or a virtual machine on an infrastructure service. The server program can be implemented using a programming language interpreter or runtime environment, for example a Python runtime or a JavaScript runtime, and can use libraries for network communication, data parsing, and machine learning, such as HTTP client libraries, JSON processing libraries, and machine learning frameworks.

The terminal includes at least one processor, a wireless communication module, a display, and user input components such as a touch screen. The terminal executes a client application that communicates with the server via a communication network using a protocol such as HTTPS. The terminal can be implemented as a mobile information processing device or a portable information processing device. The terminal further includes an operating system providing a location acquisition function and a secure storage function.

The user operates the terminal to register initial preferences and permissions. The user provides consent for acquisition of schedule information from an external schedule management apparatus and for acquisition of location information from a positioning function of the terminal. The user also configures profile attributes such as preferred clothing styles, clothing sizes, and budget ranges. The terminal stores these settings in a local data structure such as a key-value store or a lightweight relational store and then transmits them to the server as structured messages.

The server stores user context information in a relational data store such as a row-oriented database. The server assigns a unique identifier to each user and maintains tables including a user profile table, a weather context table, a schedule context table, a recommendation table, and a product association table. Each table uses primary keys and foreign keys so that records can be linked across tables. For example, the recommendation table includes fields for a user identifier, a recommendation identifier, a time stamp, a list of clothing elements, and references to associated schedule events and weather intervals.

The server acquires weather data from an external weather information providing apparatus by issuing requests through the network interface. The server constructs request packets including at least a location parameter and an access key, and transmits them over the network using a secure transport protocol. The external apparatus returns weather data in a structured format such as a JSON document. The server parses this document and materializes weather records into an internal data structure such as an array of weather entries, each including a time field, a temperature field, a precipitation field, and a condition code.

The server normalizes the weather data by applying deterministic transformations. The server converts temperature values into a unified unit, quantizes continuous values into discrete temperature bands, and assigns condition categories based on condition codes. The server maps each weather record to a time bucket, such as an hourly interval, and stores these normalized entries into the weather context table. This normalization reduces the dimensionality and variability of the raw data, which enables the server to perform subsequent computations more efficiently and to reduce model input complexity.

The server acquires schedule information from an external schedule management apparatus by using standardized interfaces. The server may receive schedule information via the terminal or may directly connect to the schedule management apparatus using authenticated requests. The schedule information is represented as event objects including at least a start time, an end time, a title, and optionally a description and a location. The server converts time values into a normalized time representation and stores events in the schedule context table. The server classifies schedule information into event types and clothing requirement levels by executing an analysis subroutine. In one embodiment, the server uses a hybrid approach combining rule-based keyword detection and a trained text classification model. The server tokenizes event titles and descriptions, converts tokens into embedding vectors, and applies a lightweight neural network classifier. The classifier can be implemented as a feed-forward neural network including an input layer for embedding vectors, at least one hidden layer with nonlinear activation functions, and an output layer that outputs probabilities over event type categories such as business, casual, outdoor, and exercise. The server assigns to each event the category with the highest probability above a threshold and stores the result as an event type field.

The server further assigns clothing requirement levels by mapping event types and known attributes to levels of formality, warmth, and protection. For example, a business category with a meeting attribute may be mapped to a “high formality” level, whereas an outdoor category occurring at low temperatures may be mapped to a “high warmth” level. These mappings are stored in a rule set table, and the server retrieves and applies them using deterministic lookup operations.

The server applies a rule set that associates clothing elements with environmental and activity conditions. The rule set is stored as machine-readable records specifying conditions over temperature bands, precipitation categories, event types, and requirement levels, and specifying resulting clothing elements. A clothing element is represented as a structured object including a category attribute (for example top, bottom, outerwear, footwear, or accessory), a formality attribute, a warmth attribute, a water-resistance attribute, and optional style tags. The server retrieves relevant rules by matching current normalized weather records and event classifications, and then computes a union or intersection of resulting clothing elements. The server resolves conflicts by selecting elements that satisfy the strictest applicable requirement for each attribute. This deterministic rule processing yields basic clothing candidates with reduced ambiguity.

The server generates a prompt sentence for a generative AI model on the basis of the basic clothing candidates and the user context information. The server constructs the prompt sentence as a text string that follows a controlled template. The template concatenates segments describing the weather summary, schedule summary, user preferences, and the list of basic clothing candidates. The server ensures that the prompt sentence includes explicit constraints and explanation requirements so that the generative AI model produces stable, context-aligned output.

In one example, the server generates the following prompt sentence:

“You are a fashion assistant. Today's weather in the user's region is sunny, with a high of 26 degrees Celsius and a low of 18 degrees Celsius, and almost no chance of rain. The user has a business meeting from 3:00 PM to 4:00 PM and will commute outdoors by train for 30 minutes. The user prefers slightly casual but acceptable business outfits. The base rule engine suggests: long-sleeve dress shirt, lightweight jacket, slacks, and leather shoes. Please refine this outfit, suggest concrete clothing combinations, and explain the reasons in simple language.”

In another example, when the user provides an additional preference, the server generates the following prompt sentence:

“Given today's weather in the user's region, the user's business meeting this afternoon, and the user's preference for casual but neat outfits under a specified budget, please propose a complete outfit and list specific clothing items that satisfy these constraints, explaining why they are suitable.”

The server transmits the prompt sentence and structured context information to a generative AI model executed on a separate processing system or as a service. In one embodiment, the generative AI model is a transformer-based language model constituted by multiple layers of self-attention and feed-forward sublayers. The model has been pre-trained on large amounts of text data and optionally fine-tuned on domain-specific data such as fashion descriptions and outfit recommendations. The server supplies the prompt sentence as the initial input sequence, and the model processes the sequence through its layers, computing attention scores, hidden representations, and output token probabilities. During training, the model minimizes a loss function such as a cross-entropy loss between predicted tokens and ground truth tokens, and the model parameters are updated by gradient-based optimization. During inference, the server configures decoding parameters such as temperature and maximum length to balance determinism and diversity.

The server receives from the generative AI model a response sequence representing a clothing proposal and an explanation in natural language. The response may include detailed item descriptions, color suggestions, and justification based on weather and schedule. The server parses the response by using a response template or pattern matching to extract item descriptions into a structured data format. The server maps textual item descriptions to clothing element categories and attributes, and stores them in the recommendation table together with the textual explanation.

The terminal receives from the server the structured data representing the clothing proposal and explanation. The terminal renders this structured data in a graphical user interface. The terminal can group items by category, display key attributes, and show the explanation text to the user. The user can view the proposal, accept or ignore items, or provide feedback in natural language by inputting additional prompt sentences. The terminal transmits these additional prompt sentences to the server, which integrates them into updated prompt sentences to the generative AI model. This creates an interactive feedback loop enabling dynamic refinement of the clothing proposal.

The server acquires product data from a store product information management apparatus when the user is in or near a store. The server or the terminal detects store proximity using mechanisms such as geofencing, short-range communication signals, or manual user input. The product data include product identifiers, categories, sizes, colors, prices, and stock levels. The server standardizes these data into a product catalog structure with indexed fields for efficient querying.

The server performs association between clothing proposals and products by matching structured clothing elements to product attributes. The server can use a similarity function that compares clothing element attributes such as category, formality, warmth, and color with product category codes and tags. The server ranks products by similarity score and availability, and stores association information linking each recommended clothing element to one or more concrete products. The server then sends association information to the terminal.

The terminal presents specific purchasable products that correspond to the recommended clothing elements. The terminal displays product images, prices, and availability, and can assist the user in locating products within a physical store by showing location identifiers or navigation hints. The user can restrict the display to products within a certain budget or to specific colors, and the terminal relays these constraints to the server, which recalculates product rankings.

The server improves computer technology in several ways. Because the server normalizes weather and schedule data into compact, discrete representations, the size and variability of inputs to the rule engine and to the generative AI model are reduced. This improves processing speed and decreases the amount of network bandwidth required to transmit context to remote components. The rule-based pre-selection of basic clothing candidates restricts the search space for the generative AI model, which reduces inference time and leads to more deterministic outputs, thereby improving computational efficiency and stability. The server constructs prompt sentences using a structured template derived from normalized data rather than arbitrary user text. This reduces unnecessary ambiguity and enables the generative AI model to reuse internal representations across similar contexts, improving effective accuracy of the generated proposals. Because the server maintains a pipeline in which each stage (normalization, classification, rule application, prompt generation, generative inference, and product association) uses well-specified data structures and algorithms, debugging and optimization at the system level are facilitated. This pipeline design differs from a mere automation of human decision-making. The server performs operations such as vector-space classification of events, multi-stage rule resolution across environmental and activity dimensions, and symbolic-to-numeric matching for product association, which are non-intuitive for manual processing but well suited to digital computation.

The generative AI model is not used in isolation. Instead, the server constrains and guides the model with algorithmically derived context and enforces a post-processing step that converts free-form text into structured records. This combination improves the repeatability and reliability of the system's behavior, which is a technical improvement over conventional, unconstrained text generation. The server can further log intermediate states, monitor error rates in classification and association, and adapt its rule parameters based on feedback, thereby reducing systematic errors and improving long-term performance.

In alternative embodiments, the server can employ different classification algorithms for event typing, such as support vector machines or convolutional neural networks operating on character sequences. The generative AI model can have a different architecture, such as a recurrent neural network with attention mechanisms. The rule set can be implemented as a decision tree, a rule-based expert system, or a learned decision table. The product association engine can use approximate nearest neighbor search or embedding-based similarity between clothing descriptions and product descriptions to improve matching speed on large catalogs. Multiple servers can share a distributed in-memory cache to store frequently used weather and schedule patterns, thereby reducing external queries and further lowering communication load.

In another embodiment, the terminal can perform a part of the computation, such as preliminary location-dependent weather caching or on-device filtering of product lists based on user preferences, to reduce the load on the server and the network. The user can operate the terminal to generate additional prompt sentences such as “I want a more casual version of this outfit that is still acceptable for a client meeting” or “Please adjust the outfit using only items under my budget,” and the terminal transmits these prompt sentences to the server for incorporation into the prompt generation process. In each case, the server orchestrates a sequence of specialized data transformations that enhance the operation of the computing infrastructure itself, including improved data management, reduced communication overhead, and enhanced accuracy and speed of context-aware recommendations.

Through these configurations, the server, the terminal, and the user cooperate to implement the claimed system in a way that allows a person skilled in the art to practice the invention, while achieving technical effects such as improved processing efficiency, increased robustness of AI-based recommendations, and effective linkage between high-level recommendations and concrete products in real-world environments.

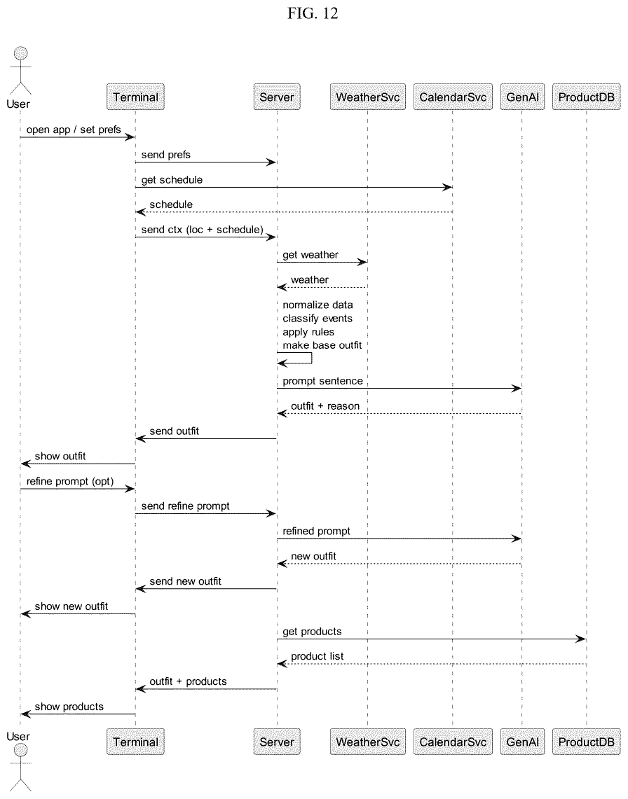

The following describes the processing flow using FIG. 12.

Step 1:

User configures initial settings and permissions.

User operates the terminal to launch the application and inputs profile information such as clothing size ranges, style preferences, and budget constraints. User grants or denies permissions for location acquisition and schedule acquisition.

Input: User taps and types on the terminal UI to provide preferences and permission choices.

Processing: Terminal converts the user inputs into structured key-value pairs and permission flags, and validates formats (for example, numeric ranges and allowed option values).

Output: Terminal stores a user settings object in local storage and prepares a user context initialization message for the server.

Step 2:

Terminal transmits initial user context to the server.

Terminal packages the user settings object, including profile attributes and permission flags, into a structured message. Terminal establishes an HTTPS connection to the server and sends this message.

Input: User context initialization message generated in Step 1.

Processing: Terminal serializes the data into a network payload (for example, JSON), encrypts it via a transport security protocol, and sends it to a designated server endpoint.

Output: Server receives a user context initialization request containing profile and permission data.

Step 3:

Server stores and indexes user profile data.

Server parses the received initialization request and extracts profile fields and permission indicators.

Input: Serialized profile and permission data from the terminal.

Processing: Server deserializes the payload, validates required fields, and generates or retrieves a unique user identifier. Server writes profile records into a user table and related tables in a data store, setting indexes on keys such as user identifier and region codes.

Output: Server persists a normalized user profile and returns an acknowledgment including the user identifier to the terminal.

Step 4:

Terminal acquires current location and current time for the user.

Terminal invokes operating system APIs to obtain location coordinates and the local time.

Input: Operating system location permission state and time information from the terminal clock.

Processing: Terminal calls a location service interface, receives coordinates and accuracy metrics, and retrieves the current time zone and timestamp. Terminal encapsulates this information in a location context object.

Output: Terminal produces a location and time context and holds it for transmission to the server.

Step 5:

Terminal acquires schedule information from an external schedule management apparatus.

Terminal, if permitted, authenticates the user to the schedule service and requests events for a target period.

Input: User permission flag for schedule access and an access token or credentials.

Processing: Terminal sends a schedule request via an API call to the external schedule management apparatus, receives event data in structured form, and parses it into an internal event list with start times, end times, titles, and optional descriptions.

Output: Terminal generates a schedule context object that represents upcoming user events.

Step 6:

Terminal transmits combined context to the server.

Terminal combines the location and time context from Step 4 and the schedule context from Step 5 into a single message.

Input: Location context object, schedule context object, and stored user identifier.

Processing: Terminal merges these structures, attaches the user identifier, serializes the merged structure, and sends it to the server using a secure network protocol.

Output: Server receives a context message containing location, time, and schedule information tied to a user identifier.

Step 7:

Server acquires and normalizes weather data.

Server uses the location information to request weather data from an external weather information providing apparatus.

Input: User location (for example, latitude and longitude) and possibly a target time range.

Processing: Server constructs an external request with location and time parameters, sends it via a network interface, and receives raw weather data including temperature, precipitation, and condition codes. Server converts temperature units if needed, assigns values to discrete temperature bands, and groups weather records into time buckets aligned with the schedule.

Output: Server creates and stores a normalized weather dataset associated with the user and current context.

Step 8:

Server normalizes and stores schedule events.

Server processes the schedule context sent by the terminal to create a time-aligned representation of user activities.

Input: Schedule context object from Step 6.

Processing: Server converts event times into a standard time zone, validates time formats, and stores each event in a schedule table with fields such as start time, end time, title, and description. Server constructs a timeline structure that can be intersected with time buckets of the normalized weather data.

Output: Server produces a schedule timeline aligned with weather time buckets.

Step 9:

Server classifies events into event types and clothing requirement levels.

Server analyzes event titles and descriptions to derive semantic categories relevant to clothing.

Input: Timeline of events with textual fields and time intervals.

Processing: Server tokenizes event titles and descriptions, converts tokens into numeric vectors (for example, via an embedding matrix), and feeds these vectors into a classification subroutine such as a feed-forward neural network. The subroutine outputs probabilities over event categories, and the server assigns an event type to each event based on the maximum probability above a threshold. Server then consults a rule table that maps event types to clothing requirement levels for formality, warmth, and protection.

Output: Server generates an annotated event list where each event includes an event type and associated clothing requirement levels.

Step 10:

Server constructs an environment-activity matrix.

Server combines normalized weather data and classified schedule data into a composite representation.

Input: Normalized weather time buckets from Step 7 and annotated event list from Step 9.

Processing: Server intersects event time intervals with weather time buckets to create segments describing what activity occurs under which weather condition. For each segment, server computes aggregated attributes such as average temperature band, maximum precipitation probability, and main activity type.

Output: Server creates an environment-activity matrix that describes combined weather and schedule conditions over time.

Step 11:

Server applies a rule set to generate basic clothing candidates.

Server uses the environment-activity matrix and stored rule records to determine a base outfit.

Input: Environment-activity matrix and rule set records defining clothing element conditions.

Processing: Server iterates over each environment-activity segment, evaluates rule conditions (such as temperature band≥threshold and precipitation category=rainy), and collects resulting clothing elements. Server accumulates clothing elements across segments, resolving conflicts by selecting the most restrictive or frequently required attributes.

Output: Server outputs a set of basic clothing candidates represented as structured clothing elements with attributes for category, formality, warmth, and protection.

Step 12:

Server incorporates user profile constraints into basic clothing candidates.

Server refines the basic set to fit user-specific constraints stored in the profile.

Input: Basic clothing candidates from Step 11 and user profile data from Step 3.

Processing: Server filters out clothing elements that conflict with size ranges or banned categories, adjusts formality levels according to user preferences, and enforces budget-related tags such as “low cost” or “mid range.” Server can reweight elements based on the user's historical acceptance, if available.

Output: Server produces a profile-adjusted set of basic clothing candidates.

Step 13:

Server generates a prompt sentence for the generative AI model.

Server converts context and basic clothing candidates into a textual instruction.

Input: Normalized weather summary, event summaries, profile-adjusted clothing candidates, and user preferences.

Processing: Server fills a prompt template by inserting weather descriptions, activity descriptions, and the list of basic clothing candidates. Server adds explicit instructions to ask for concrete items and explanations.

Output: Server outputs a prompt sentence such as:

“You are a fashion assistant. Today's weather in the user's region is sunny, with a high of 26 degrees Celsius and a low of 18 degrees Celsius, and almost no chance of rain. The user has a business meeting from 3:00 PM to 4:00 PM and will commute outdoors by train for 30 minutes. The user prefers slightly casual but acceptable business outfits. The base rule engine suggests: long-sleeve dress shirt, lightweight jacket, slacks, and leather shoes. Please refine this outfit, suggest concrete clothing combinations, and explain the reasons in simple language.”

Step 14:

Server queries the generative AI model using the prompt sentence.

Server sends the prompt to a generative AI model and receives a response.

Input: Prompt sentence from Step 13 and, optionally, serialized context features.

Processing: Server transmits the prompt to an AI service endpoint. The generative AI model processes the prompt through a sequence of neural network layers to generate token probabilities and then produces output tokens representing sentences with clothing proposals and explanations. Server receives the output text.

Output: Server obtains a raw text response including a refined clothing proposal and an explanation in natural language.

Step 15:

Server parses and structures the generative AI response.

Server converts the free-form response into machine-readable records.

Input: Raw text response from Step 14.

Processing: Server applies pattern rules or a secondary lightweight parser to detect item descriptions, such as “navy blazer” or “white cotton shirt,” and associated rationale segments. Server maps textual terms to clothing categories, colors, and attributes, and writes them into recommendation records. Server attaches the explanation text to the recommendation identifier.

Output: Server generates structured recommendation data including item entries and explanation strings.

Step 16:

Server transmits recommendation data to the terminal.

Server prepares the structured recommendation for presentation to the user.

Input: Structured recommendation data from Step 15 and user identifier.

Processing: Server constructs a response message containing clothing items, attributes, and explanation text, and sends it to the terminal over a secure network connection.

Output: Terminal receives a recommendation message containing an AI-refined outfit and explanation.

Step 17:

Terminal displays the clothing proposal and explanation to the user.

Terminal renders the received data in a user interface.

Input: Recommendation message from Step 16.

Processing: Terminal parses the message, builds UI components such as lists or cards for each clothing item, and displays the explanatory text. Terminal may apply local formatting (for example, fonts and colors) and schedule notifications for later viewing.

Output: User views a structured outfit proposal and a justification on the terminal display. Step 18:

User optionally provides an additional prompt sentence for refinement.

User interacts with the displayed recommendation to modify constraints or request alternatives.

Input: Visual presentation of the current outfit proposal.

Processing: User types a prompt such as “I want a more casual version suitable for the same meeting” or “Please keep the total cost under my budget.” Terminal captures the text and associates it with the current recommendation identifier.

Output: Terminal produces an additional prompt object tied to a context identifier.

Step 19:

Terminal sends the additional prompt sentence and context back to the server.

Terminal enriches the new prompt with current recommendation context.

Input: Additional prompt object from Step 18 and latest recommendation data.

Processing: Terminal packages the user's text with identifiers for the existing recommendation and sends this packet to the server.

Output: Server receives a refinement request containing the user's new prompt and the reference to existing structured recommendations.

Step 20:

Server generates an updated prompt sentence including user refinement.

Server integrates the new user input into a revised instruction for the generative AI model.

Input: Original prompt context, structured recommendation data, and additional user prompt from Step 19.

Processing: Server appends the user's new constraints to the original prompt sentence or creates a new sentence referencing the prior proposal, describing which elements should change and which should remain. Server may also include data about budget or style constraints extracted from the user's input.

Output: Server outputs a refined prompt sentence similar to:

“I like the previous navy blazer and white shirt combination, but I prefer a more casual look without a tie, and the total cost should stay under the user's budget. Please adjust the outfit while keeping it appropriate for a client meeting and explain the changes.”

Step 21:

Server re-queries the generative AI model and updates the structured recommendation.

Server obtains a revised outfit and explanation from the generative AI model.

Input: Refined prompt sentence from Step 20.

Processing: Server sends the refined prompt to the generative AI model, receives a new text response, and repeats the parsing and structuring procedure to create an updated recommendation. Server may compare attribute changes against the previous recommendation and store a version history.

Output: Server produces an updated structured recommendation and explanation and transmits them to the terminal.

Step 22:

Server acquires product data from a store product information management apparatus.

Server or terminal detects that the user is associated with a particular store and initiates product data retrieval.

Input: Store identifier and possibly category filters derived from recommendation items.

Processing: Server sends product queries to the product information management apparatus and receives product data including identifiers, categories, sizes, prices, and stock status. Server transforms this data into standardized product records indexed by category and attributes.

Output: Server holds a product catalog relevant to the user's context.

Step 23:

Server associates recommended clothing elements with concrete products.

Server matches recommendation items to product entries in the catalog.

Input: Structured recommendation data from Step 15 or Step 21 and standardized product catalog from Step 22.

Processing: Server computes similarity measures between clothing element attributes and product category tags, filters products by size and price constraints from the user profile, and ranks candidate products by similarity and availability. Server writes association records that map each recommended item to one or more product identifiers.

Output: Server produces association information linking clothing proposals to specific products.

Step 24:

Server transmits product association information to the terminal.

Server prepares combined recommendation and product information for user presentation.

Input: Association information and corresponding recommendation identifiers.

Processing: Server embeds product identifiers, names, prices, and optional store location information into a response message alongside the clothing elements.

Output: Terminal receives an extended recommendation message containing both abstract clothing items and concrete products.

Step 25:

Terminal presents purchasable products corresponding to the outfit.

Terminal integrates product data into the user interface.

Input: Extended recommendation message from Step 24.

Processing: Terminal displays lists or grids of specific products grouped under each recommended clothing element, showing prices and availability, and optionally store location hints. Terminal may allow the user to filter products by additional constraints such as maximum price or preferred colors.

Output: User views a complete set of outfit recommendations coupled with concrete products that can be selected or purchased in the real world.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional outfit recommendation systems typically rely on static rule sets or simple filtering based on coarse user attributes, such as season and a small number of style labels. Such systems generally do not perform deep natural language understanding of user inputs expressed as free-form sentences, and they do not robustly integrate heterogeneous contextual data, such as fine-grained weather forecasts, detailed schedule information, and nuanced user preferences, into a unified decision process. As a result, conventional systems often provide generic recommendations that are poorly aligned with real-world constraints (for example, time-specific weather conditions and event formality) and with the user's individual preferences.

Furthermore, typical systems treat user input and context acquisition as loosely connected steps: a user may manually input a date or select a location, and the system separately fetches weather data or calendar data without resolving ambiguous or relative temporal expressions (for example, “tomorrow morning” or “this weekend”) contained in natural language sentences. This fragmented processing results in ambiguity in the target time window, which degrades the relevance and reliability of the recommendations and increases the need for user intervention.

In addition, existing systems generally do not employ a generative AI model in a manner that exploits rich, structured context derived from multiple external sources. Even when a generative AI model is used, it is often prompted directly with the raw user text without systematic extraction and formalization of key parameters, such as location, time range, event type, formality level, indoor/outdoor classification, and weather context. This leads to inconsistent outputs and can increase computational load, because the model must implicitly infer structure that could be made explicit by pre-processing on the server side.

Moreover, many systems do not support iterative, dialog-based refinement of outfit proposals using additional prompt sentences while maintaining a coherent context state. When a user requests modifications, the system frequently restarts the recommendation process without leveraging previously assembled context data, resulting in redundant computation and delayed responses, and making it difficult to achieve a smooth interactive user experience from a computing-system perspective.

There is therefore a need for an improved computer-implemented technique that (i) accurately parses natural language prompt sentences to extract structured context parameters; (ii) automatically resolves relative time expressions to concrete time ranges; (iii) efficiently acquires and aggregates external weather information and schedule information into machine-usable context data; (iv) constructs precise prompts for a generative AI model based on the integrated context data; and (v) supports iterative refinement of outfit proposals while reusing context and minimizing redundant processing. Such a technique should improve the operation of the computer system itself by organizing computation into clear stages, reducing ambiguity and unnecessary model calls, and enabling more efficient and context-aware use of generative AI resources.

The specific processing by the specific processing unit 290 of the data processing device 12 in Example 2 is realized by the following means.

The present invention provides a server comprising a processor configured to parse a natural language prompt sentence acquired from a user via a communication device, extract structured parameters including location information, time information, event information, and preference information from the prompt sentence, acquire weather information from an external information providing device based on at least the location information and the time information, aggregate weather data for a time period corresponding to the event information to generate weather context information including at least temperature information and precipitation probability information, acquire schedule information from an electronic schedule management device based on the time information, generate schedule context information including at least a formality level of an event and an indoor/outdoor classification based on the event information and the schedule information, integrate the weather context information, the schedule context information, and the prompt sentence to generate context data, generate a model prompt for instructing a generative AI model to generate outfit proposal information based on the context data, obtain the outfit proposal information from the generative AI model, generate outfit configuration information including clothing items, colors, and optionally outerwear based on the outfit proposal information, acquire product information from a product information providing device based on the outfit configuration information, generate proposal message data associating the product information with the outfit configuration information, and transmit the proposal message data to the communication device via a communication application. This enables the computer system to perform context-aware outfit recommendation processing by decomposing natural language input into explicit machine-usable context, reducing ambiguity in time and event interpretation, minimizing redundant generative AI processing, and improving overall computational efficiency and responsiveness while delivering outfit proposals that are better aligned with real-world constraints and user preferences.

The term “processor” refers to a hardware information processing element, such as a central processing unit or a combination of processing cores, configured to execute program instructions and perform arithmetic, logical, control, and input/output operations.

The term “communication device” refers to an electronic apparatus, such as a mobile terminal, a tablet device, or a personal computer, that is capable of transmitting and receiving data via a communication network and presenting information to a user.

The term “natural language prompt sentence” refers to a text input expressed in a human language, provided by a user, that includes at least one instruction, request, or description to be processed by an information processing system.

The term “location information” refers to data indicating a geographical position associated with a user or an event, including, for example, a city name, a region name, or geographic coordinates.

The term “time information” refers to data indicating a temporal point or period, including, for example, an absolute date and time or a relative time expression such as “tomorrow” or “this weekend.”

The term “event information” refers to data indicating a planned activity or situation relevant to outfit selection, including, for example, a meeting, a dinner, a ceremony, or an outdoor activity.

The term “preference information” refers to data indicating a user's individual tastes or constraints related to clothing, such as preferred styles, colors, or levels of formality.

The term “external information providing device” refers to a server or service system configured to supply data to another system via a communication network, including, for example, a weather information service.

The term “weather information” refers to data describing meteorological conditions for a given location and time, including at least temperature, precipitation probability, and weather condition type.

The term “weather context information” refers to structured data derived from weather information, representing summarized or aggregated meteorological conditions for a relevant time period in a form usable for outfit recommendation.

The term “temperature information” refers to data indicating at least one of a predicted minimal temperature, a predicted maximal temperature, or an average temperature for a specified period and location.

The term “precipitation probability information” refers to data indicating a likelihood of precipitation, expressed, for example, as a probability or percentage, for a specified period and location.

The term “electronic schedule management device” refers to an information processing system that stores and manages schedule data such as calendar entries, and that can provide such data via an application programming interface.

The term “schedule information” refers to data indicating one or more planned events, including at least event times, event titles, and optionally event locations or descriptions.

The term “schedule context information” refers to structured data derived from schedule information, representing characteristics of events, including at least a formality level and an indoor/outdoor classification, in a form usable for outfit recommendation.

The term “formality level” refers to a classification value indicating a required or recommended degree of formality of an event, such as formal, semi-formal, or casual.

The term “indoor/outdoor classification” refers to data indicating whether an event is to be held primarily inside a building or outside, based on event information, schedule information, or both.

The term “context data” refers to data obtained by integrating at least weather context information, schedule context information, and a natural language prompt sentence, and representing comprehensive conditions for use in generating an outfit proposal.

The term “generative AI model” refers to a machine learning model configured to generate output data, such as text, based on input data, using learned parameters obtained from training on a dataset.

The term “model prompt” refers to structured input data, including text and optionally metadata, supplied to a generative AI model to instruct the model to perform a specific generation task.

The term “outfit proposal information” refers to data output by a generative AI model that suggests one or more clothing combinations or styles suitable for given context data.

The term “outfit configuration information” refers to structured data derived from outfit proposal information, specifying concrete clothing elements, including at least clothing items, colors, and optionally outerwear.

The term “clothing items” refers to individual wearable products, such as tops, bottoms, footwear, or accessories, that together form an outfit.

The term “outerwear” refers to clothing items that are worn over other garments, such as jackets, coats, or blazers, typically used for warmth or protection.

The term “product information providing device” refers to an information processing system, such as a merchandise server, configured to provide product-related data including at least product identifiers, descriptions, and links.

The term “product information” refers to data describing goods, including at least one of product names, categories, prices, availability, and access information such as resource locators.

The term “proposal message data” refers to message content generated for delivery to a user, including at least outfit configuration information and product information associated with the outfit configuration information.

The term “communication application” refers to software executed on a communication device and configured to send and receive messages via a communication network, including, for example, a messaging application or a chat application.

The term “reference time information” refers to data representing a base time, such as a current system time or a specified time point, used to interpret relative time expressions as absolute date and time.

The term “absolute date and time” refers to a concrete temporal value expressed in a specific calendar and time format, such as a particular year, month, day, hour, and minute.

The term “target acquisition period” refers to a specific time range determined based on time information, used as a criterion when acquiring weather information and schedule information.

The term “additional prompt sentence” refers to a natural language input provided by the user after an initial outfit proposal has been generated, the input requesting modification, refinement, or further specification of the proposal.

The term “dialog control” refers to processing for managing iterative interactions with a user by updating context data and model prompts based on additional prompt sentences and previously generated information.

In one embodiment, a server, a terminal, and a user cooperate to implement the invention. The server includes at least one processor, a memory, a non-transitory storage medium, and a network interface. The processor executes programs stored in the memory to realize the functional units described below. The terminal includes a processor, a display, an input interface such as a touchscreen or keyboard, and a communication module, and runs a communication application. The user operates the terminal to input a natural language prompt sentence and to view outfit proposals.

The server executes an application stack implemented, for example, using an operating system such as a Linux-based server OS, an application framework such as a web framework, and libraries for machine learning such as Python with a tensor computation library (for example, PyTorch or TensorFlow). The server may include a graphics processing unit, such as a general-purpose GPU, to accelerate matrix operations used by a generative AI model. The generative AI model may be implemented as a transformer-based neural network having an embedding layer, a plurality of self-attention layers, and a decoding layer. The server stores model parameters, such as weight matrices and bias vectors, learned in advance by supervised or self-supervised training on text data.

The terminal runs a communication application such as a messaging application, which may be implemented on a mobile operating system such as a smartphone OS or a desktop OS. The terminal displays a text input field through which the user inputs a natural language prompt sentence. The terminal transmits the prompt sentence, together with user identification data and context data, to the server via a communication network such as the internet, using a protocol such as HTTPS.

The user inputs, as one example, a prompt sentence such as:

“Tomorrow in Tokyo will be sunny. Please recommend an outfit suitable for a casual business meeting. I prefer simple and minimalist styles.”

In another example, the user inputs a prompt sentence such as:

“It might rain in Osaka this Saturday. I have an outdoor family picnic. Please suggest comfortable and water-resistant clothing for me.”

These prompt sentences contain mixed information, including relative time expressions (“tomorrow,” “this Saturday”), location names (“Tokyo,” “Osaka”), event descriptions (“casual business meeting,” “outdoor family picnic”), and preference descriptions (“simple and minimalist styles,” “comfortable and water-resistant clothing”).

The server stores the received prompt sentence in the memory as a character string and also stores metadata such as a user identifier, a reception timestamp, and a conversation session identifier. The server then performs natural language analysis on the prompt sentence. The server converts the prompt sentence into a sequence of tokens using a tokenizer corresponding to the vocabulary of the generative AI model or a separate analysis model. The server maps each token to an integer index and then to an embedding vector of fixed dimension, thereby forming a tensor representing the prompt sentence.

The server executes a natural language understanding model, which can be a transformer encoder network distinct from the generative AI model used for text generation. The natural language understanding model includes multiple attention heads and feed-forward sublayers. The server applies the token embeddings to this network to compute contextualized embeddings. On the basis of these embeddings, the server performs classification and sequence labeling to extract structured parameters, including location information, time information, event information, and preference information. For example, the server assigns labels such as “LOCATION,” “TIME,” “EVENT,” and “PREFERENCE” to substrings of the prompt sentence using a sequence tagging head. The server then groups tokens having the same label to obtain phrases corresponding to each kind of information.

The server converts the extracted time information, which may include relative time expressions, to absolute date and time values. The server uses the system clock to obtain a reference time. The server applies dedicated rules and machine-learned models to interpret expressions such as “tomorrow” as the next calendar day relative to the reference time, and to interpret expressions such as “this Saturday” as the next occurrence of that weekday. The server also determines an approximate time range for the event by interpreting expressions such as “morning,” “afternoon,” or “evening,” mapping these to predefined time intervals. The server stores the resulting absolute start and end times in a time context data structure. The server maps the extracted location information to geographic coordinates. The server may access a geographic database or a geocoding service to obtain latitude and longitude values corresponding to a city name or region name. The server therefore obtains normalized location data usable as input for a weather information service.

The server communicates with an external information providing device, which functions as a weather information server. The server sends a request including at least the geographic coordinates and the target time range. The external server returns weather data in a structured format such as JSON, containing, for example, predicted temperatures, precipitation probabilities, and weather condition codes at various times. The server parses this data and aggregates it into weather context information. The server calculates minimum, maximum, and average temperatures over the target time range by performing numerical operations such as scanning through forecast records and applying comparison and accumulation operations. The server also computes an aggregate precipitation probability and determines a dominant weather condition based on frequency of occurrence or severity indicators. The server stores the weather context information in a dedicated data structure that includes fields for temperature information, precipitation probability information, and condition indicators. The server accesses an electronic schedule management device, which may be an online calendar system. The server sends a query specifying the user identifier and the target date or time range. The schedule management device returns schedule information, including one or more events with start times, end times, titles, and descriptions. The server parses this schedule information to identify events relevant to outfit selection. The server compares the event times with the time context derived from the prompt sentence and selects overlapping or nearby events. The server applies rule-based classification and optionally a trained classifier to determine a formality level (for example, formal, semi-formal, casual) and an indoor/outdoor classification for each event. For instance, if an event title contains terms related to “meeting” or “interview,” the server may assign a semi-formal level. If an event location contains words corresponding to parks or outdoor venues, the server may assign an outdoor classification.

The server consolidates the event classifications into schedule context information. The schedule context information includes at least one representative formality level and an indoor/outdoor classification that are most relevant to the time range and location derived from the prompt sentence. The server may apply priority rules, such as preferring the most formal event within the time range when determining the overall formality level to be used as context. The server stores the schedule context information in a structured object including fields for formality level, indoor/outdoor classification, and event summary.

The server then integrates the weather context information, the schedule context information, and key portions of the original prompt sentence into unified context data. The server constructs a text representation of the context data to be used as input for a generative AI model. This text may include sentences such as: “Location: Tokyo. Date: [absolute date]. Weather: sunny, 18-24 degrees Celsius, low chance of rain. Event: casual business meeting in an office, indoor. User style preference: simple and minimalist.” The server may also retain structured context as a separate data structure for further processing, but the integration into text is used to form a model prompt.

The server formulates a model prompt designed to cause the generative AI model to output a specific type of response. The server includes instructions such as “recommend a complete outfit including top, bottom, shoes, and optional outerwear,” and may specify constraints such as “respect the user's style preferences and the weather conditions.” The server concatenates these instructions with the context text to generate the final model prompt sentence for the generative AI model.

The server applies the model prompt to a generative AI model. The generative AI model may be implemented as a transformer decoder or an encoder-decoder network that takes the prompt tokens as input and generates output tokens autoregressively. The server tokenizes the model prompt, performs embedding lookup, and executes the transformer layers on the processor or GPU. The transformer layers perform multi-head attention by computing query, key, and value vectors from the embeddings, performing scaled dot-product attention, and propagating the results through feed-forward networks. The server uses parameters obtained from prior training, where the model has been trained on large text corpora using a loss function such as cross-entropy, and weights have been updated by an optimization algorithm such as stochastic gradient descent or a variant thereof. During inference in this system, the server does not modify the learned weights but carries out deterministic or sampling-based decoding to produce an output sequence of tokens.

The server decodes the generated tokens into human-readable text, which constitutes the outfit proposal information. As one example, the server may obtain text such as:

“For a sunny day in Tokyo with temperatures between 18 and 24 degrees, a simple and minimalist outfit for a casual business meeting would include a plain light blue shirt, slim-fit navy chinos, and clean white leather sneakers. Bring a lightweight navy blazer in case the office is cool.”

In another example, the server may obtain text such as:

“For an outdoor family picnic in Osaka with possible rain, consider a lightweight waterproof hooded jacket, a breathable T-shirt, quick-drying pants, and water-resistant sneakers. Choose darker colors for the pants to avoid visible stains.”

The server converts the outfit proposal information into outfit configuration information. The server analyzes the generated text using pattern matching, parsing, or a secondary classifier to extract explicit clothing items, such as “light blue shirt,” “navy chinos,” and “white leather sneakers,” as well as characteristics such as color (“light blue,” “navy,” “white”) and type (“shirt,” “pants,” “sneakers,” “jacket”). The server stores each extracted element as a record in an outfit configuration data structure, associating item type, color, and optional attributes such as material or length. This structure may be represented as an internal object graph or as relational database entries.

The server accesses a product information providing device, which may be an online merchandise server. The server sends search queries formed from the outfit configuration information, such as “men's light blue cotton shirt” or “navy slim-fit chinos.” The product information providing device returns product information records including product identifiers, descriptions, prices, and resource locators such as URLs. The server performs ranking or filtering of the returned products based on rules such as relevance to the configuration, user price range, or stock availability.

The server associates selected product information with corresponding elements of the outfit configuration information to generate proposal message data. The proposal message data may include text describing the recommended outfit, together with product names and clickable links to product pages. The server formats the proposal message data as a message object conforming to the interface of the communication application used by the terminal.

The server transmits the proposal message data to the terminal via the communication application. The server uses a messaging interface, such as a REST-based messaging API, to send the message to an account associated with the user. The server may also manage conversation state by storing the latest context data and outfit configuration information in a session store, allowing subsequent user interactions to build upon existing context. The terminal receives the proposal message as a communication payload and displays the message on the display device. The terminal renders the text and, where applicable, hyperlinks or buttons corresponding to product URLs. The user views the recommendation and may optionally select links to open a web browser or in-app browser to view product details. From the user's perspective, the system presents a coherent recommendation that already accounts for weather, schedule, and preferences, without requiring the user to manually check forecasts or calendars.

The server supports iterative interaction by allowing the user to send additional prompt sentences after viewing an initial proposal. For example, the user may send: “Please suggest an alternative outfit with darker colors and no sneakers.” The terminal transmits this additional prompt sentence to the server. The server identifies the additional prompt sentence as belonging to an existing session based on an identifier. The server parses the additional prompt sentence, extracts updated preference information (for example, “darker colors,” “no sneakers”), and reintegrates this information into the existing context data. The server updates the formality level, style preferences, or item constraints in the context data, and then regenerates a revised model prompt for the generative AI model. This process avoids recomputing weather and schedule context, thereby reducing redundant processing and improving responsiveness.

From a technical perspective, this architecture improves computer technology in several ways. By separating natural language understanding (extraction of structured parameters) from generative text production, the server reduces the burden on the generative AI model to infer structure from raw text. The server only supplies concise, structured context to the model, which reduces the length of the input sequence, thereby decreasing computational cost in the transformer layers and shortening inference time. The use of explicit time normalization from relative expressions to absolute timestamps allows the server to perform precise queries against weather and schedule services, which improves the correctness of the resulting context data and, ultimately, the accuracy of the outfit proposals.

The server's use of dedicated data structures for weather context information and schedule context information allows caching and reuse of intermediate results for multiple user inquiries that share common parameters, such as the same date and location. This reduces network traffic to external services and lessens communication load. Furthermore, the classification of events into formality levels and indoor/outdoor categories through specialized algorithms reduces ambiguity that would otherwise require repeated generative inference, thus enhancing computational efficiency.

The server employs machine-learned models and rule-based logic according to non-conventional processing flows. Unlike human operators who might manually interpret text, check weather websites, and inspect calendars, the server uses transformer-based embeddings, learned attention patterns, and pre-defined classification rules to systematically decompose and normalize the input, then recombine data into optimized prompts. Because the processing chain is structured into stages that operate on well-defined internal data representations, the server can perform optimizations such as partial recomputation, parallelization of weather and schedule retrieval, and batch processing of model prompts for multiple users.

The generative AI model itself may be trained using a large corpus of text that includes instructions and responses, using an objective function such as next-token prediction. During training, the server or an offline training system computes gradients of the loss function with respect to the model parameters using backpropagation, and updates the parameters with an optimizer. Data augmentation techniques, such as random masking of tokens or paraphrasing of instructions, can be used to improve generalization. By using a trained transformer model with multiple layers and attention heads, the system can capture complex relations between context elements and clothing recommendations in a way that traditional rule-based systems cannot. The deployment of this model inside the described architecture yields faster and more accurate outputs than a straightforward human-style manual processing implemented on a computer.

Because the system generates and maintains explicit context data, the server can also implement validation and correction mechanisms. For example, if weather context information indicates heavy rain and low temperature, but the initial outfit proposal lacks outerwear, the server can apply additional rule checks to enforce inclusion of protective clothing before sending the message to the user. Such post-processing rules operate on the outfit configuration information data structure and allow further control of quality, which contributes to accuracy and reliability.

In alternative embodiments, the server may host the generative AI model locally or may access a remote inference service. In a local-hosted embodiment, the server loads the model weights into GPU memory at startup and keeps the model resident, which reduces latency per request compared to reloading the model. In another embodiment, multiple models may be used: one relatively small model for quick extraction of context parameters, and a larger model for generating detailed, stylistically rich text. The server may choose between models based on system load, thereby optimizing resource usage.

In another variation, the terminal may perform part of the natural language understanding locally using a lighter-weight model deployed on the terminal. In this case, the terminal extracts certain parameters such as location and time from the prompt sentence and sends a structured representation in addition to or instead of the raw text. The server then focuses on integration with external data sources and generative output. This division of labor can further reduce server-side computational load and improve scalability of the system. Through these configurations, the system does more than automate a human task. The server reorganizes the computation into a sequence of machine-optimized stages, uses neural network models in conjunction with specialized data structures and rule-based components, and achieves technical effects such as faster processing, reduced network calls, improved utilization of processor and memory resources, and enhanced accuracy of predictions. The close coupling of time normalization, context aggregation, and generative model prompting, and the maintenance of dialog state for iterative refinement, collectively provide an improvement in computer functionality related to context-aware recommendation processing.

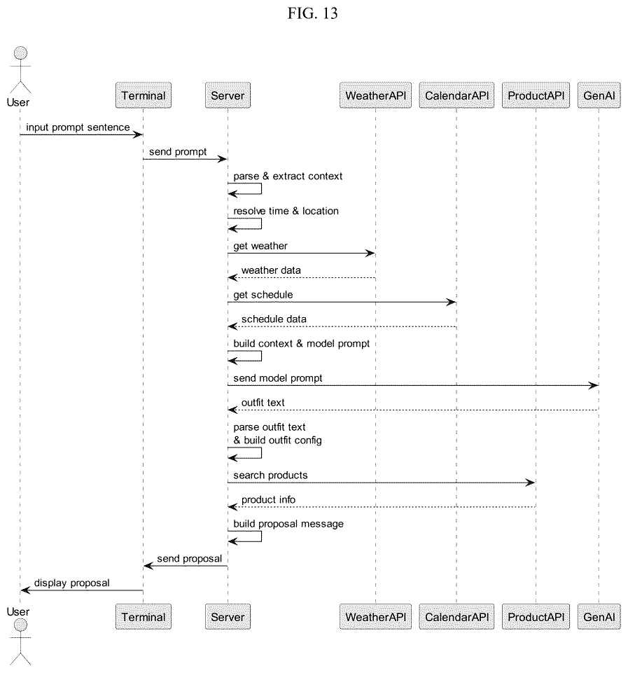

The following describes the processing flow using FIG. 13.

Step 1:

User operates the terminal to open a communication application and inputs a natural language prompt sentence into a text input field. The input of this step is the user's free-form text (for example, “Tomorrow in Tokyo will be sunny. Please recommend an outfit suitable for a casual business meeting. I prefer simple and minimalist styles.”). The terminal captures the text string, appends metadata such as a user identifier, device identifier, and a local timestamp, and packages these into a message object. The output of this step is the message object containing the prompt sentence and metadata ready to be transmitted to the server.

Step 2:

Terminal transmits the message object to the server via a network interface using an encrypted communication protocol. The input of this step is the message object created in Step 1. The terminal performs data serialization (for example, converting the message to a JSON payload), opens a secure connection (for example, HTTPS), and sends an HTTP request to a server endpoint. The output of this step is a network request containing the prompt sentence and metadata, delivered to the server's communication interface.

Step 3:

Server receives the network request at an application endpoint and stores the prompt sentence and metadata in memory. The input of this step is the serialized network payload from the terminal. The server parses the payload, extracts fields such as the prompt sentence text, user identifier, and timestamp, and writes these into internal data structures (for example, an in-memory object and a log entry in a database). The output of this step is a normalized internal representation of the user request that can be accessed by subsequent processing modules.

Step 4:

Server performs tokenization and initial natural language preprocessing on the prompt sentence. The input of this step is the text string representing the prompt sentence. The server applies a tokenizer compatible with the generative AI model or an auxiliary analysis model, splitting the sentence into tokens and mapping each token to an integer index. The server may apply additional preprocessing such as lowercasing, Unicode normalization, and removal of control characters. The output of this step is a token sequence and associated indices that represent the prompt sentence in a machine-readable form.

Step 5:

Server executes a natural language understanding model to extract structured parameters from the token sequence. The input of this step is the token sequence produced in Step 4. The server loads an encoder-type neural network (for example, a transformer encoder implemented with a tensor computation library) and feeds the token indices into an embedding layer to obtain embedding vectors. The server propagates these embeddings through multiple self-attention and feed-forward layers to obtain contextualized embeddings. Based on these embeddings, the server applies a sequence labeling head and classification layers to assign labels such as “LOCATION,” “TIME,” “EVENT,” and “PREFERENCE” to tokens and to group labeled tokens into phrases. The output of this step is structured parameter data including at least location information, time information, event information, and preference information extracted from the prompt sentence.

Step 6:

Server converts relative time expressions in the time information into absolute date and time values. The input of this step is the extracted time information together with a reference time obtained from the system clock. The server applies rule-based logic and, if necessary, a trained temporal parsing model to interpret relative expressions such as “tomorrow” and “this Saturday” as specific calendar dates. The server also interprets coarse time descriptors such as “morning” or “evening” to assign approximate start and end times. The server performs arithmetic operations on date and time values to compute a target time window. The output of this step is normalized time information containing absolute start and end timestamps for use in querying external data sources.

Step 7:

Server resolves the extracted location information into normalized geographic data. The input of this step is the location phrase (for example, “Tokyo” or “Osaka”) extracted in Step 5. The server queries a geographic database or geocoding service, sending the location phrase as a search key. The server receives candidate locations, selects the most relevant entry using ranking rules, and retrieves corresponding geographic coordinates such as latitude and longitude. The output of this step is normalized location information including, at minimum, coordinates and standardized place names.

Step 8:

Server acquires weather information from an external information providing device using the normalized time and location information. The input of this step is the geographic coordinates and the absolute time window produced in Steps 6 and 7. The server constructs a request to a weather information service, specifying parameters such as latitude, longitude, and time range, and sends the request via a network interface. The server receives forecast data in a structured format containing multiple records of temperature, precipitation probability, and weather conditions over time. The output of this step is raw weather data aligned to the requested location and time.

Step 9:

Server aggregates the raw weather data into weather context information. The input of this step is a set of weather records returned in Step 8. The server iterates over the records that fall within the target time window, and performs numeric calculations to determine minimum, maximum, and average temperatures. The server computes an aggregate precipitation probability (for example, by taking the maximum or weighted average) and identifies a dominant weather condition based on occurrence counts or specified priority rules. The server then stores these aggregated values into a dedicated weather context data structure. The output of this step is weather context information including temperature information, precipitation probability information, and at least one representative condition descriptor.

Step 10:

Server acquires schedule information from an electronic schedule management device based on the normalized time information. The input of this step is the absolute date or time window from Step 6 and a user identifier that allows access to the user's schedule. The server sends a query to a calendar or schedule server, specifying the user and the relevant time range. The schedule management device returns a set of events, each including fields such as start time, end time, title, location, and description. The output of this step is raw schedule data for the user for the specified period.

Step 11:

Server generates schedule context information by classifying events in the raw schedule data. The input of this step is the event list obtained in Step 10. The server filters events that overlap or closely neighbor the target time window using comparisons of timestamps. For each such event, the server applies rule-based classification and optionally a trained classifier using features derived from event title, description, and location, to assign a formality level (for example, formal, semi-formal, casual) and an indoor/outdoor classification. The server then selects or combines these classifications to derive representative values for the context period and stores them in a schedule context data structure, along with a summary of event characteristics. The output of this step is schedule context information containing at least a formality level and an indoor/outdoor classification linked to the time window and location.

Step 12:

Server integrates the weather context information, the schedule context information, and the original prompt sentence into context data. The input of this step is the weather context information from Step 9, the schedule context information from Step 11, and the original prompt sentence text from Step 3. The server constructs an internal object that links these components and may also generate a human-readable description string summarizing the context (for example, “Location: Tokyo; Date: [date]; Weather: sunny, 18-24° C., low rain probability; Event: casual indoor business meeting; Preference: simple and minimalist styles.”). The server writes this integrated representation into memory as context data. The output of this step is unified context data that will condition the subsequent generative AI model processing.

Step 13:

Server generates a model prompt for the generative AI model based on the context data. The input of this step is the unified context data generated in Step 12. The server concatenates instruction text (for example, “You are a fashion assistant. Recommend a complete outfit including top, bottom, shoes, and optional outerwear.”) with the context description string. The server formats this combined text as a model prompt sentence and may apply tokenization or encoding if required by the generative AI model interface. The output of this step is a model prompt designed to cause the generative AI model to produce an outfit proposal consistent with the context.

Step 14:

Server applies the model prompt to the generative AI model and obtains outfit proposal information. The input of this step is the model prompt text from Step 13. The server tokenizes the prompt, converts tokens to embeddings, and executes the forward pass of a transformer-based generative AI model using processor or GPU resources. The model computes successive layers of attention and feed-forward transformations and decodes output tokens according to an algorithm such as greedy decoding or beam search. The server then converts the output token sequence into text. The output of this step is outfit proposal information in natural language form, describing recommended clothing items and composition.

Step 15:

Server converts the outfit proposal information into outfit configuration information. The input of this step is the generated text from Step 14. The server applies parsing routines, keyword extraction, and pattern matching, or a secondary classifier, to identify explicit clothing items, colors, and optional outerwear specified in the text. The server creates structured records for each identified item, including attributes such as category (top, bottom, footwear, outerwear), color, and potential material or style. The output of this step is outfit configuration information represented as a structured data set that specifies each element of the recommended outfit.

Step 16:

Server acquires product information from a product information providing device using the outfit configuration information. The input of this step is the structured outfit configuration from Step 15. The server generates search queries based on item attributes (for example, “light blue cotton shirt,” “navy slim-fit chinos,” “white leather sneakers”) and sends these queries to a merchandise server. The merchandise server returns product data including product identifiers, descriptions, prices, and links. The server evaluates the returned items using relevance scoring rules and filters out unsuitable products. The output of this step is a selected set of product information records associated with each clothing item in the configuration.

Step 17:

Server generates proposal message data by combining the outfit configuration information with the selected product information. The input of this step is the outfit configuration information and corresponding product information from Step 16. The server composes a message body that includes a descriptive explanation of the recommended outfit, references to each clothing item, and product links or identifiers mapped to these items. The server formats this message according to the messaging protocol of the communication application, embedding URLs or other actionable elements as needed. The output of this step is proposal message data ready to be delivered to the terminal.

Step 18:

Server transmits the proposal message data to the terminal via the communication application interface. The input of this step is the formatted proposal message generated in Step 17 and the user identifier or conversation identifier stored in Step 3. The server constructs an outbound message request, including destination information and the message payload, and sends it to the messaging platform or directly to the terminal using a network protocol. The server may also update a session record to reflect that a response has been sent. The output of this step is a network message containing the proposal, delivered to the terminal's communication application.

Step 19:

Terminal receives the proposal message and displays the outfit recommendation to the user. The input of this step is the inbound message payload received from the server or messaging platform. The terminal's communication application parses the payload, extracts text and link information, and renders the content in a chat or message interface on the display. The terminal may generate a notification alert to draw the user's attention. The output of this step is a graphical and textual presentation of the outfit proposal on the terminal screen, enabling the user to view recommended clothing items and, if desired, follow links to product pages.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional outfit recommendation systems generally apply fixed rules or simple filtering logic to user attributes, such as size or static style preferences, and optionally to environmental data, such as temperature. These systems typically operate as passive catalog browsers that merely narrow down items. As a result, they fail to leverage rich context signals, including real-time user emotional state, schedule-dependent formality requirements, and evolving user feedback, and they do not exploit generative artificial intelligence models in a technically structured way. From a computer-technology perspective, this leads to several problems.

First, existing systems do not manage contextual data in a way that enables efficient and consistent prompt generation for a generative AI model. In many implementations, context such as weather, schedule, and user profile is either not integrated at all or is integrated in an ad hoc manner at the application layer, resulting in unstructured and verbose prompts that provide inconsistent conditioning to the model. This degrades the quality and determinism of the generated output and increases the computational resources wasted on irrelevant or redundant conditions.

Second, known systems do not dynamically adjust prompts based on machine-interpretable schedule categories and emotion signals. For example, a schedule event may be labeled simply as a text string (e.g., meeting), and emotion may be treated as a coarse sentiment value, without a defined mapping from these machine-interpretable states into structured prompt constraints, such as explicit formality level, activity type, or color tone bias. This absence of a prompt-level control layer prevents the generative model from being systematically steered toward outputs that satisfy both formal constraints (such as business appropriateness) and soft constraints (such as mood alignment), and forces developers to rely on repeated retrials or manual prompt tweaks, which is inefficient at scale.

Third, conventional systems generally treat the output of a generative AI model as unstructured natural language text. They do not include programmatic mechanisms to parse generated descriptions into machine-readable item elements, associate those elements with catalog records, and feed back the result of that association into subsequent prompt construction. Consequently, downstream processes such as product retrieval, display, and logging must perform costly and unreliable free-text matching, which increases processing latency, reduces recommendation accuracy, and complicates system maintenance.

Fourth, existing systems rarely incorporate explicit user feedback loops into the generative pipeline at the prompt-construction level. Even when some form of feedback (e.g., “like” or “dislike” buttons) is collected, it is often stored only for analytics or offline retraining, and not applied in real time to modify the structure, parameterization, or constraints of future prompts. This lack of prompt-level adaptation causes the system to repeatedly generate similar outputs that may not match the user's evolving preferences or emotional patterns, thereby wasting computational resources and degrading user experience.

Accordingly, there is a need for a computer-implemented system that (i) programmatically constructs and adjusts prompt sentences for a generative AI model based on multi-source contextual data including emotion, weather, schedule, and user attributes, (ii) transforms model outputs into structured, catalog-linked representations suitable for efficient processing, and (iii) incorporates user evaluation signals into the prompt-generation logic. Such a system should improve the technical functioning of the recommendation pipeline itself, by organizing data flow, reducing unnecessary interactions with the generative model, and enabling more targeted and resource-efficient generation.

The specific processing by the specific processing unit 290 of the data processing device 12 in Application Example 2 is realized by the following means.

The present invention provides a server comprising a processor configured to analyze user voice information and user image information to identify an emotional state of a user, generate a prompt sentence to be input to a generative information processing model based on weather information and seasonal information acquired from an external information providing apparatus, the emotional state, user behavioral schedule information, and user attribute information, adjust the prompt sentence to optimize a clothing recommendation by the generative information processing model by adding, to the prompt sentence, conditions relating to a formality level and an activity type in accordance with contents of the behavioral schedule information, analyze clothing recommendation information output from the generative information processing model to structure the clothing recommendation information into clothing elements and accessory elements and associate the structured clothing recommendation information with merchandise information stored in a merchandise information storage apparatus, transmit the associated clothing recommendation information to a terminal apparatus via a communication function, and update contents of generation and adjustment of the prompt sentence based on evaluation information of the user acquired from the terminal apparatus. This enables the computing system to transform heterogeneous contextual inputs into a structured, machine-interpretable prompt control layer for the generative AI model, to obtain structured and catalog-linked outputs from the model, and to adapt the prompt construction logic in real time based on user feedback, thereby improving the technical efficiency, accuracy, and controllability of the computer-implemented recommendation process.

The term “processor” refers to a hardware computation unit or a combination of hardware and firmware that executes machine-readable instructions to perform data acquisition, analysis, generation, adjustment, and communication operations described in this specification.

The term “user” refers to a human individual who interacts with the system, provides input data such as voice information, image information, and schedule information, and receives clothing recommendations via a terminal apparatus.

The term “voice information” refers to audio data representing spoken utterances of the user, including waveform data or encoded audio frames suitable for processing by speech analysis or emotion recognition components.

The term “image information” refers to visual data representing at least a portion of the user, such as still images or video frames including a face or body, suitable for processing by image analysis or emotion recognition components.

The term “emotional state” refers to a classification or representation of the user's psychological condition, such as joy, sadness, neutrality, or other affective categories, derived from analysis of voice information, image information, text information, or combinations thereof.

The term “external information providing apparatus” refers to a remote computing resource or information service that supplies environmental or contextual data, including but not limited to weather information and seasonal information, to the processor via a communication network.

The term “weather information” refers to data describing environmental conditions associated with a geographic region and time, including at least one of temperature, precipitation, humidity, wind, and sky condition.

The term “seasonal information” refers to data indicating a temporal context such as season, period, or historical average environmental conditions relevant to a geographic region, used to characterize typical temperature ranges or weather patterns.

The term “user behavioral schedule information” refers to structured data representing planned or recorded user activities, including event times, event types, and contextual descriptions, obtained from a schedule management apparatus or similar source.

The term “user attribute information” refers to data describing characteristics or preferences of the user, including at least one of style preference, size information, color preference, purchase history, and demographic attributes.

The term “generative information processing model” refers to a machine learning model or artificial intelligence model configured to generate output information, such as text or structured data, based on an input prompt sentence, including but not limited to a generative language model.

The term “prompt sentence” refers to a machine-readable or human-readable input expression comprising one or more sentences or phrases supplied to the generative information processing model to specify context, constraints, and desired characteristics of the model's output.

The term “formality level” refers to a representation of a required degree of dress code or stylistic strictness for an outfit, including, for example, formal, semi-formal, business, smart casual, and casual levels.

The term “activity type” refers to a classification of a user activity associated with a schedule event, such as business activity, private activity, or ceremonial activity, which influences constraints applied to a clothing recommendation.

The term “clothing recommendation information” refers to output data generated by the generative information processing model indicating suggested outfit configurations, including references to clothing elements, accessory elements, colors, and styles.

The term “clothing element” refers to a unit component of an outfit, such as a top, bottom, outerwear, footwear, or other wearable article intended to be worn on a human body.

The term “accessory element” refers to a wearable or carryable item that complements clothing elements, such as jewelry, watches, belts, bags, scarves, or similar decorative or functional items.

The term “merchandise information” refers to data describing items available for acquisition, including identifiers, categories, sizes, colors, prices, stock states, and descriptive attributes maintained in a storage apparatus.

The term “merchandise information storage apparatus” refers to a storage subsystem, such as a database system or file storage system, configured to store and provide access to merchandise information for use by the processor.

The term “terminal apparatus” refers to an endpoint device operated by the user, including at least one of a mobile communication device, a wearable device, or a computing terminal, configured to present recommendations and capture user input or evaluation information.

The term “communication function” refers to hardware and software capabilities enabling data transmission and reception between the processor, the external information providing apparatus, the schedule management apparatus, the merchandise information storage apparatus, and the terminal apparatus over a communication network.

The term “evaluation information” refers to feedback data generated by the user in response to a clothing recommendation, including explicit ratings, selection actions, acceptance or rejection signals, or similar indicators of user preference or satisfaction.

The term “schedule management apparatus” refers to a computing resource or service that stores and provides schedule information for the user, including calendar entries, events, and reminders, accessible to the processor via a communication interface.

The term “business activity” refers to an activity associated with professional or occupational contexts, such as meetings, presentations, office work, or formal business events.

The term “private activity” refers to an activity associated with personal or non-professional contexts, such as leisure, casual gatherings, or individual errands.

The term “ceremonial activity” refers to an activity associated with formal social or cultural events, such as ceremonies, celebrations, commemorations, or other events requiring elevated formality.

The term “information transmission apparatus” refers to a communication subsystem, which may be implemented as a server, gateway, or messaging platform, that relays or delivers structured data, including notification data, between the processor and the terminal apparatus.

The term “notification data” refers to message content generated by the processor for presentation at the terminal apparatus, including at least one of structured clothing recommendation information, merchandise information, explanatory text, and interactive elements enabling user response.

In one embodiment, a server cooperates with a terminal and a user to implement a clothing recommendation system that uses a generative AI model and prompt sentences constructed from multi-source context data. The server executes a program on one or more physical processors, such as a multi-core central processing unit and optionally a graphics processing unit or dedicated AI accelerator, within a network-connected computing device.

The terminal is implemented as an information processing device such as a smartphone, tablet, or wearable device having a display, a microphone, a camera, a wireless communication interface, and local storage. The user interacts with the terminal to provide consent, voice information, image information, and evaluation information.

The server operates on a general-purpose operating system, such as a UNIX-like operating system or another multi-task operating system, and executes application software implemented, for example, using a programming language such as a scripting language or a compiled language. The server includes modules such as an emotion analysis module, a context management module, a prompt generation module, a generative AI interface module, an output structuring module, a merchandise association module, and a feedback adaptation module. These modules are realized as executable instructions and data structures stored in a non-transitory storage medium such as a magnetic storage device or a solid-state storage device and loaded into main memory for execution by the processor.

The terminal executes an application program that controls hardware resources including a microphone, a camera, a touch panel, and a wireless transceiver. The terminal uses an operating system-provided media framework to acquire audio frames and image frames. For example, the terminal uses a camera control framework to capture image information including the user's face, and uses an audio capture framework to record voice information while the user speaks for a predetermined duration. The terminal compresses the captured data into encoded formats such as compressed audio and compressed image files, and transmits the encoded data to the server through a communication network using secure transport protocols.

The server receives the voice information and the image information from the terminal and stores them in a structured data repository. The server applies a feature-extraction pipeline to these data. For voice information, the server computes acoustic features such as mel-frequency cepstral coefficients, pitch contours, energy values, and temporal derivatives of these quantities. For image information, the server applies a convolutional feature extractor to obtain spatial feature maps representing facial landmarks, expression-related regions, and local texture descriptors. The server concatenates or otherwise combines these feature vectors to form an input representation for an emotion classifier.

In one embodiment, the server implements the emotion classifier as a neural network model having a hybrid architecture. The server uses a convolutional sub-network for processing image features and a recurrent or transformer-based sub-network for processing temporal sequences of audio features. The server feeds the outputs of these sub-networks into a fully connected decision layer that outputs probabilities for a plurality of emotional states such as joy, sadness, anger, and neutrality. The server stores trained weights of this network in a parameter table and performs inference by executing matrix multiplications and non-linear activation functions on the processor or the AI accelerator. The server determines the emotional state of the user by selecting an emotional category whose output probability exceeds a predetermined threshold or by selecting a category with a maximum probability. The server further acquires environmental information and schedule information. The server sends requests to an external information providing apparatus, such as a remote weather service, via a communication network. The server includes in the request a location identifier and a time or season identifier. The external apparatus returns weather information including present or forecast temperature, precipitation, and other conditions, and may also return seasonal information such as an average temperature for a relevant period. The server parses the returned data into structured fields and stores them in a context data store.

The server obtains user behavioral schedule information from a schedule management apparatus, such as an electronic calendar service. The server communicates with the schedule management apparatus using an authenticated interface based on user-supplied authentication information. The server retrieves event records that define the user's upcoming or current activities. The server analyzes text fields of these event records and assigns each event to a category such as business activity, private activity, or ceremonial activity using a classification algorithm. In one embodiment, the server uses a keyword-based classifier that maps specific terms to categories, or uses a statistical classifier trained on labeled schedule data. The server stores these classifications as structured schedule attributes.

The server maintains user attribute information in a profile store. The server populates this store through long-term observation and explicit user input. The server stores attributes such as style preference, size ranges, color preferences, and historical purchase records. The server accesses this store when generating clothing recommendations and when adjusting prompt generation rules.

The server integrates the emotional state, the weather information, the seasonal information, the categorized behavioral schedule information, and the user attribute information into a context representation. The server normalizes temperatures into qualitative ranges such as hot, mild, or cold, normalizes formality requirements based on activity type, and derives color bias preferences based on the emotional state and user history. The server encodes this context representation in a data structure having explicit fields for emotion, formality level, activity type, temperature band, weather condition, and style preference.

The server constructs a prompt sentence to be input to a generative information processing model. The server does not simply concatenate arbitrary text; instead, the server follows a rule-based template system that inserts machine-interpretable context into predetermined slots. For example, the server maintains templates such as “User location: [location]. Temperature: [temperature] degrees, [condition]. Schedule: [activity type]. User emotion: [emotion]. Style preference: [style]. Past items: [items]. Please propose an outfit that satisfies [formality level] and matches this mood and weather.” The server fills the placeholders with values from the context representation.

In one exemplary case, the server generates the following prompt sentence:

“User location: Tokyo. Weather tomorrow: sunny, 20 degrees Celsius. Schedule: casual lunch with friends. User emotion: joy. Style preference: casual. Past items: jacket, denim pants. Please propose a casual outfit for tomorrow that combines the jacket and denim pants, and suggest a top, shoes, and accessories that match a joyful mood and mild weather.”

In another case, the server generates an emotion-focused prompt sentence such as:

“The user's emotion is sadness. The user prefers simple, minimalistic clothing. Please suggest an outfit with calm and comforting colors, such as navy, gray, or beige, that could help the user feel relaxed. Include tops, bottoms, shoes, and one accessory, and explain briefly why each choice is suitable for this emotion.”

The server adjusts the prompt sentence according to the behavioral schedule classification. When the server determines that an upcoming event is a business activity, the server inserts explicit constraints into the prompt sentence, for example, “The outfit must be appropriate for a business meeting, with a formal or semi-formal style.” When the server determines that the event is a private activity, the server inserts a condition allowing more casual clothing, for example, “The outfit can be casual and comfortable for leisure activities.” When the server detects a ceremonial activity, the server adds constraints such as “The outfit should be suitable for a ceremonial event with a high formality level.” By encoding these constraints in a consistent textual format, the server enables the generative AI model to more reliably produce outputs that satisfy formality requirements without additional post-processing.

The server presents the prompt sentence to the generative information processing model. In one embodiment, the generative model is a transformer-based language model having multiple self-attention layers, feedforward layers, and positional encoding mechanisms. The server operates this model as a remote service or on a local accelerator device. The server sends the prompt sentence as a sequence of tokens and receives a generated text sequence representing a clothing recommendation. Internally, the model performs attention-based scoring and weighted aggregation of token embeddings to produce probability distributions over vocabulary tokens at each step. The server configures generation parameters such as temperature, maximum token length, and repetition penalties, which influences both computational cost and determinism.

The server structures the generated clothing recommendation information using parsing rules. In one embodiment, the server configures the generative model with an instruction in the prompt sentence to output description segments in a consistent order, such as “tops: . . . , bottoms: . . . , outerwear: . . . , shoes: . . . , accessories: . . . ”. The server then parses these segments using deterministic patterns and extracts clothing elements and accessory elements. In another embodiment, the server instructs the generative model to use a clearly delimited format that can be reliably parsed. This structuring step transforms unstructured natural language into a machine-readable representation with explicit fields for item type, material, color, and style tags.

The server associates the structured clothing elements with merchandise information stored in a merchandise information storage apparatus. The server uses attribute-based matching techniques that map descriptive terms to catalog attributes. For example, the server maps the color description “light blue” to a normalized color category, maps item types such as “cotton shirt” to product categories, and filters catalog entries by size and availability. The server computes similarity scores between the recommended attributes and catalog items using vector similarity or rule-based scoring. The server selects one or more candidate merchandise items for each clothing element and links their identifiers and metadata to the recommendation record.

The server transmits the resulting clothing recommendation information, including structured outfit elements and associated merchandise identifiers, to the terminal via a communication function. The server packages the data as notification data containing at least text descriptions and, optionally, uniform resource locators or image identifiers. The server uses a messaging service or a push notification system to deliver the notification data.

The terminal receives the notification data and presents it to the user via a graphical user interface. The terminal displays the recommended clothing elements as a list or as cards, and may load and display associated product images. The user can perform selection operations such as opening a details view or indicating satisfaction or dissatisfaction with the recommendation. The terminal captures these user operations as evaluation information and transmits them to the server.

The server updates its internal prompt generation and adjustment logic based on the evaluation information. The server records which prompt patterns and context combinations led to positive evaluations, and which led to negative evaluations. The server adjusts weighting parameters of the template rules and classification thresholds. For instance, if the server observes that the user repeatedly dislikes recommendations that include bright colors on days when the emotional state is sadness, the server increases the priority of calm color constraints for that emotional state. This adaptation is implemented at the level of prompt construction, rather than only at the level of statistical analysis, and directly modifies future prompt sentences, improving the alignment between subsequent model outputs and user preferences.

This configuration yields several technical effects at the level of computer technology. Because the server constructs prompt sentences using structured context and rule-based templates, the generative AI model receives only relevant and normalized information, which reduces the length and variability of input sequences. This reduction lowers memory consumption and processing time in the transformer model, thereby improving throughput and reducing inference cost. The consistent encoding of formality level and activity type into the prompt sentence also increases the predictability of output structure, which simplifies the parsing process and reduces errors in the extraction of clothing elements.

Furthermore, the server's transformation of free-form model outputs into structured representations and their association with catalog data reduces the need for expensive and unreliable free-text search over merchandise information. Instead, the system uses attribute-based matching with normalized categories, which leads to more accurate and faster retrieval operations in the merchandise information storage apparatus. The feedback adaptation mechanism further refines these processes by statistically steering the prompt generation rules based on observed evaluation patterns, improving recommendation precision over time without requiring retraining of the underlying generative model for every user. In another embodiment, the server employs a different generative information processing model architecture, such as a sequence-to-sequence model with encoder-decoder layers, or a smaller domain-specific model deployed on an edge device. In such a case, the server adjusts the prompt sentence length and complexity according to model capacity, while preserving the explicit encoding of emotion, activity type, and formality level. The terminal and the user interaction remain similar, and the technical advantages of structured prompt construction, output structuring, and feedback-driven adaptation continue to apply.

In yet another embodiment, the server incorporates an additional rule-based layer that can override or constrain specific aspects of the generative model output. For example, the server may enforce hard constraints such as “no sleeveless tops for ceremonial activities” or “include weather-appropriate outerwear when temperature is below a threshold” by post-processing the structured output elements. This hybrid generative-plus-rules approach ensures that safety and compliance conditions are met, while still allowing the generative model to provide creative style combinations within the permitted space. This improves robustness and reduces the need for repeated user corrections, thereby reducing communication load between the terminal and the server.

The system therefore is not limited to an abstract sequence of logical or business steps, but instead specifies concrete data structures, hardware interactions, and model control mechanisms that improve the technical functioning of a computer-implemented recommendation engine. By integrating multi-modal emotion recognition, context-aware prompt sentence generation, structured output parsing, catalog association, and evaluation-driven adaptation, the server, the terminal, and the user cooperate to realize a system that enhances processing speed, accuracy, and resource usage beyond what conventional rule-based or naive generative systems can achieve.

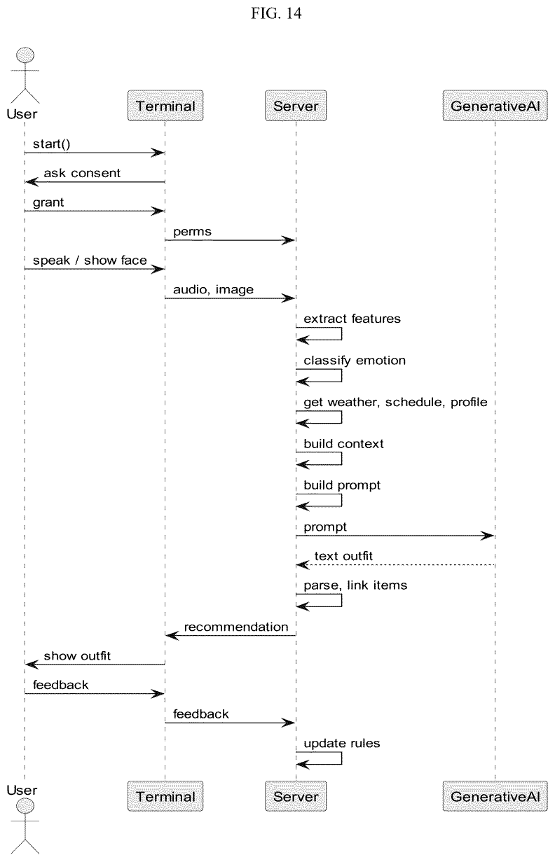

The following describes the processing flow using FIG. 14.

Step 1:

User operates the terminal to grant permissions and start recommendation processing.

User inputs consent for use of microphone, camera, schedule data, and notifications through graphical controls on the terminal.

Terminal receives the user's consent as input and updates internal permission flags.

Terminal outputs a permission status set indicating which sensors and external services (voice, image, schedule, messaging) may be accessed, and sends this status to the server.

Step 2:

Terminal acquires user voice information and image information.

Terminal uses the microphone and camera as inputs to capture a short audio segment and at least one facial image.

Terminal performs data processing by encoding the raw waveform into compressed audio and encoding raw image frames into compressed image formats, and by attaching metadata such as timestamps and device identifiers.

Terminal outputs an audio data file and an image data file, each associated with a session identifier, and transmits them to the server via a secure communication channel.

Step 3:

Server receives voice information and image information and extracts emotion features.

Server takes as input the audio file and image file sent from the terminal.

Server performs signal processing on the audio, including framing, windowing, and computing acoustic features such as mel-frequency cepstral coefficients, pitch, and energy; and performs image preprocessing such as resizing, normalization, and face detection to obtain a cropped facial region.

Server outputs an audio feature vector sequence and an image feature map, which are used as inputs to an emotion classification network.

Step 4:

Server classifies an emotional state based on combined audio and image features.

Server inputs the audio feature vector sequence and the image feature map to a neural network model comprising a convolutional sub-network for image processing, a temporal sub-network for audio processing, and a fully connected decision layer.

Server performs data computation by propagating the feature vectors through layers of linear transformations, non-linear activation functions, and normalization operations, and then computing a probability distribution over predefined emotional categories such as joy, sadness, and neutrality.

Server outputs an emotional state label and associated probability scores, and stores them in a user context record.

Step 5:

Server acquires weather information and seasonal information from an external information providing apparatus.

Server uses the user's location and current or target time as inputs, which may be received from the terminal or stored in the user profile.

Server sends a network request including these parameters to a remote weather information service, and receives weather and seasonal data as a structured response.

Server parses the response into normalized values such as current temperature, forecast temperature, weather condition, and representative seasonal average temperature, and outputs a weather context object stored in the context repository.

Step 6:

Server obtains user behavioral schedule information and categorizes activity types.

Server takes as input user authentication information and a time range (for example, today and tomorrow).

Server accesses a schedule management apparatus, retrieves event records including descriptions, times, and locations, and then runs a classification algorithm that maps event descriptions to activity types such as business activity, private activity, and ceremonial activity.

Server outputs a schedule context object containing events, associated activity types, and inferred formality levels, and stores this object in the context repository.

Step 7:

Server retrieves user attribute information from a profile store.

Server uses a user identifier as input and queries a profile database.

Server performs data retrieval and consolidation of fields including style preference, size ranges, color preferences, and historical purchase items, and may compute statistics such as most frequent item categories or most frequently selected colors.

Server outputs a user attribute object representing user preferences and history, and attaches this object to the current context record.

Step 8:

Server integrates emotion, environment, schedule, and attributes into a unified context representation.

Server takes as input the emotional state label, the weather context object, the schedule context object, and the user attribute object.

Server performs data processing by normalizing numeric values (such as temperature into “hot”, “mild”, or “cold”), mapping activity types to formality levels, and deriving color tendencies from the emotional state and color preferences.

Server outputs a context representation structure that contains fields for location, temperature band, weather condition, activity type, formality level, emotional state, style preference, and notable past items.

Step 9:

Server generates a base prompt sentence for the generative AI model.

Server inputs the context representation and selects a prompt template corresponding to the emotional state and style preference.

Server performs string construction operations by inserting context values into template slots, such that emotional state, style, and general instructions are expressed in natural language. For example, when the emotional state is sadness, the server constructs a base text emphasizing calm and comforting clothing.

Server outputs a base prompt sentence that describes the emotion, style preference, and general recommendation requirements.

Step 10:

Server adjusts the prompt sentence according to schedule and weather constraints.

Server uses the base prompt sentence and fields such as activity type, formality level, and weather condition as inputs.

Server performs rule-based modifications to append explicit constraints, such as “The outfit must be appropriate for a business meeting, with a formal or semi-formal style,” and “The temperature is 30 degrees Celsius and the weather is clear; suggest breathable and light-weight items.”

Server outputs a final prompt sentence that includes, in a single coherent text, emotional state, activity type, formality level, weather condition, style preference, and references to past items; for example:

“User location: Tokyo. Temperature: 30 degrees Celsius, clear weather. Schedule: business meeting. User emotion: joy. Style preference: casual. Past items: jacket, denim pants. Please propose an outfit that is suitable for a business meeting, but keeps a casual and bright feeling. Specify tops, bottoms, shoes, and accessories, and explain how the outfit matches the mood, weather, and schedule.”

Step 11:

Server inputs the prompt sentence to the generative AI model and generates clothing recommendation information.

Server uses the final prompt sentence as input, tokenizes the text into a sequence of tokens, and feeds this sequence into a transformer-based generative information processing model.

Server performs data computation by executing attention operations, matrix multiplications, and softmax functions within the model to iteratively predict subsequent tokens and assemble a complete textual description of a recommended outfit, under configured generation parameters such as temperature and maximum length.

Server outputs raw generated text describing tops, bottoms, outerwear, shoes, and accessories, possibly including reasoning, and records this text for subsequent parsing.

Step 12:

Server parses the generated text and structures clothing elements and accessory elements. Server takes the generated text as input and applies predefined parsing rules or delimiter patterns indicated in the prompt (for example, segments like “tops: . . . ”, “bottoms: . . . ”, “shoes: . . . ”).

Server performs text segmentation and pattern matching to extract named elements, such as item types, colors, and style notes, and then maps them into structured fields for clothing elements and accessory elements.

Server outputs a structured recommendation object containing at least one clothing element and zero or more accessory elements, each with descriptive attributes.

Step 13:

Server associates structured clothing elements with merchandise information in a storage apparatus.

Server uses the structured recommendation object as input and queries a merchandise information storage apparatus that holds catalog data for available items.

Server performs data operations by matching element attributes, such as type and color, with catalog attributes, using rule-based filters and similarity scoring to select items that best correspond to the recommended attributes, while also checking size compatibility and availability.

Server outputs a linked recommendation record that includes references to catalog item identifiers, prices, and images associated with each clothing and accessory element.

Step 14:

Server transmits the associated clothing recommendation information to the terminal via a communication function.

Server uses the linked recommendation record as input and constructs notification data that includes readable descriptions, associated catalog items, and optional links for details or purchase.

Server performs data serialization and network transmission over a messaging channel or push notification mechanism to deliver this notification data to the terminal.

Server outputs an outgoing message containing the structured recommendation and associated merchandise information, addressed to the terminal.

Step 15:

Terminal receives and displays the clothing recommendation to the user.

Terminal takes the incoming notification data as input and decodes the message payload. Terminal performs display operations by rendering the recommended outfit elements on the screen, showing item names, brief descriptions, and optional images or action buttons such as “See details” and “Like/Dislike.”

Terminal outputs a visual presentation of the recommendation and interactive controls that allow the user to evaluate or further inspect suggested items.

Step 16:

User reviews the recommendation and provides evaluation information.

User inputs an evaluation by selecting an action, such as pressing a “Like” or “Dislike” button, indicating “I wore this,” or opening and closing details without purchase.

Terminal receives these user actions as input signals from the user interface.

Terminal outputs evaluation information that encodes the type of action, a timestamp, and an identifier for the corresponding recommendation, and transmits this information to the server.

Step 17:

Server updates prompt generation and adjustment rules based on evaluation information.

Server takes evaluation information and the associated context and recommendation record as inputs.

Server performs data analysis by updating counters or weights for rules used in prompt construction, for example increasing weights for conditions that led to positive evaluations and decreasing weights for those that correlated with negative evaluations, and may adjust threshold parameters for emotion-dependent color or formality constraints.

Server outputs updated rule parameters and stores them in a configuration store, so that subsequent prompt sentences generated for the same user will be modified in accordance with observed preferences, improving precision and efficiency of future recommendations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

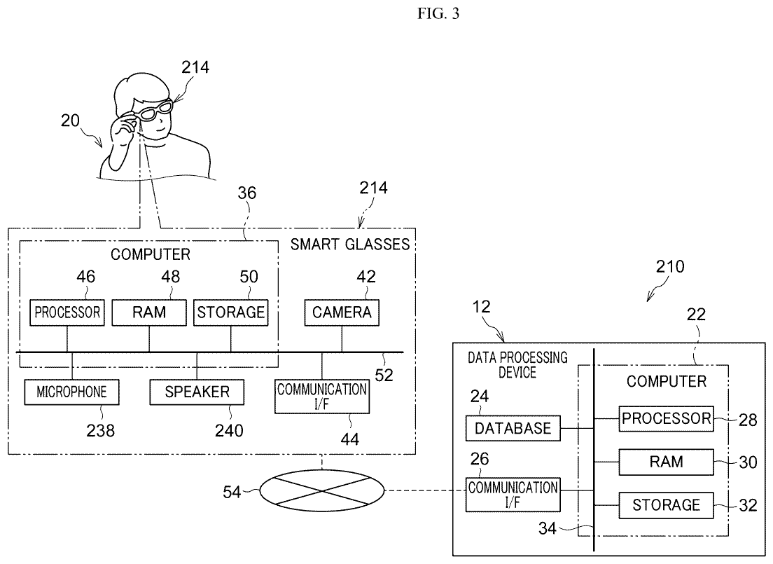

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

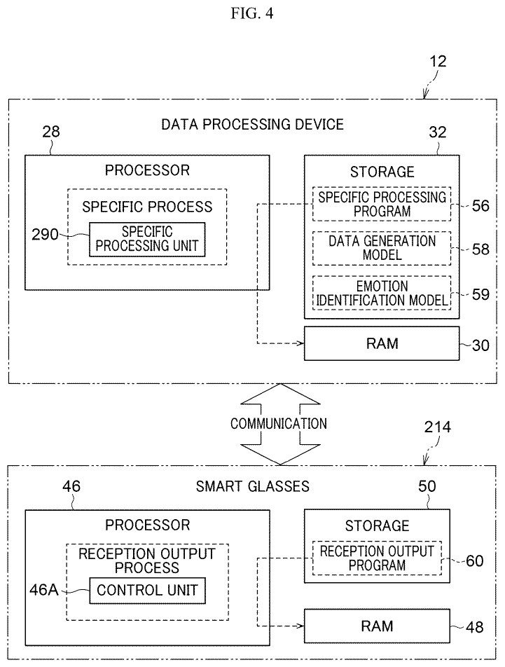

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

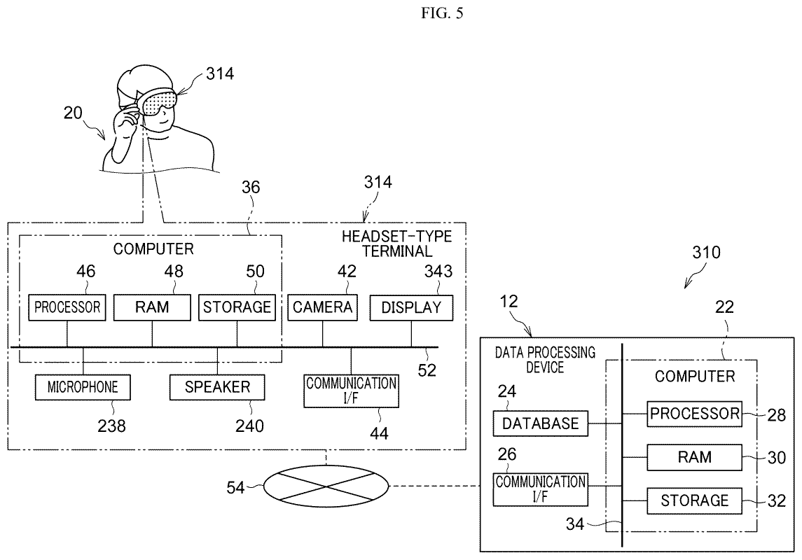

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

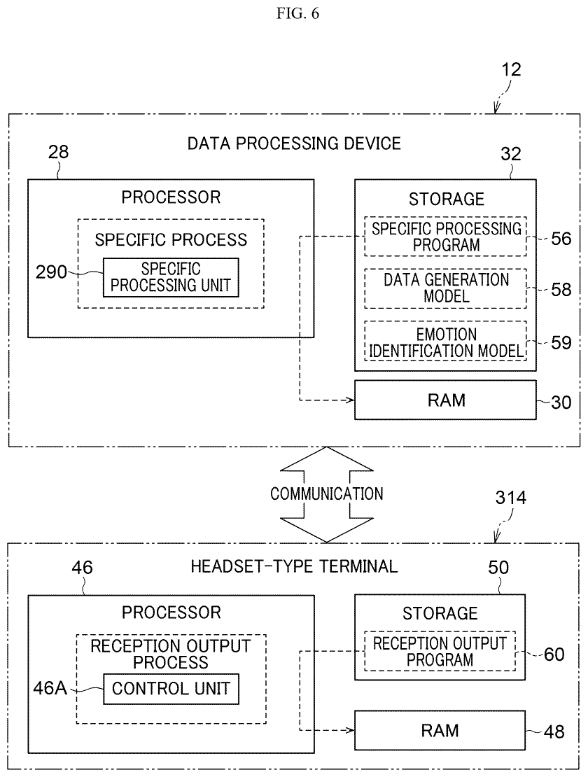

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

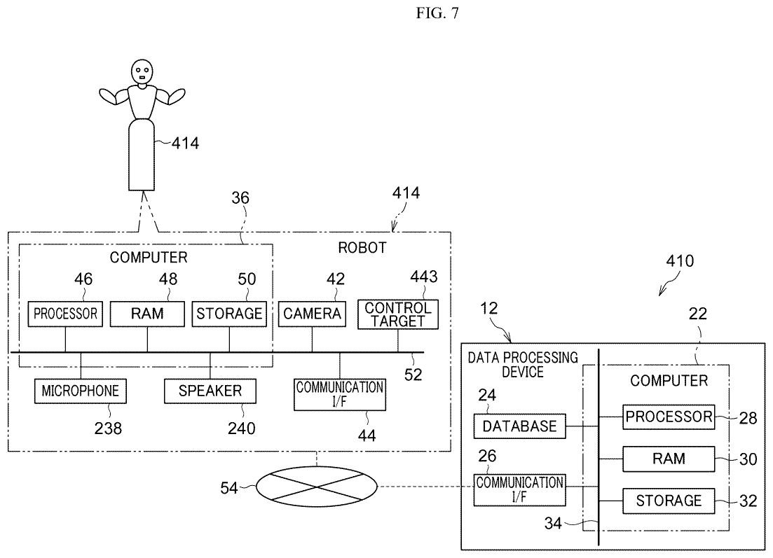

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

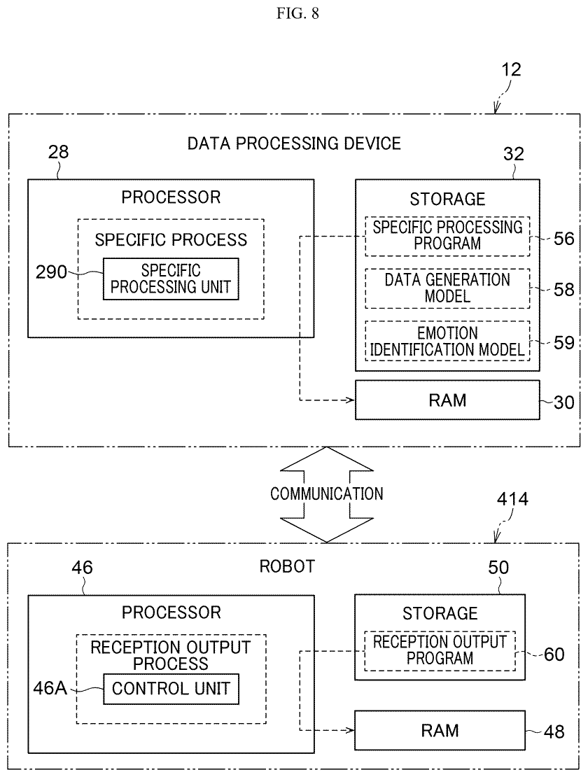

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

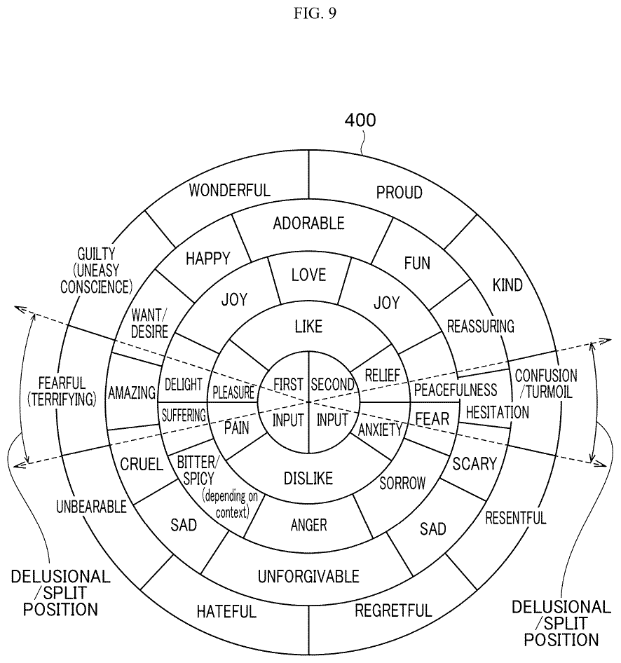

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

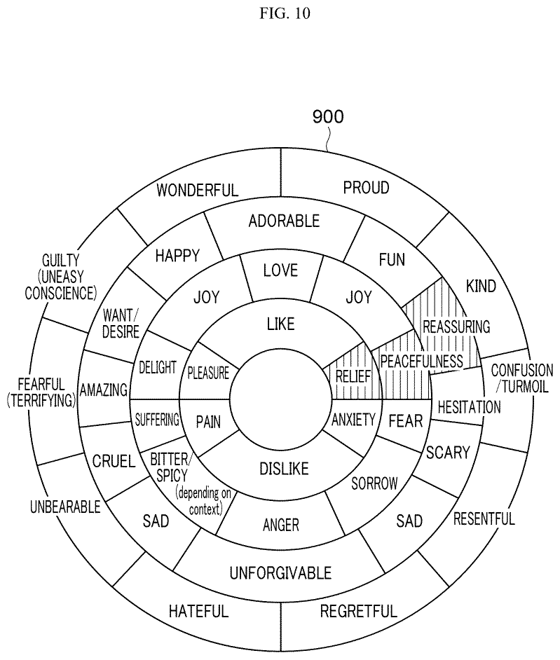

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

analyze input data including user attribute information and environment information to recognize a user state,

acquire weather information from an external information providing unit based on the recognized user state and acquired time information, and specify environmental conditions for a target day based on the weather information and the time information,

acquire schedule data from a schedule management unit based on permission from a user, and classify each scheduled item included in the schedule data as activity information including an activity type classification and an indoor/outdoor classification,

refer to clothing rule information defined for each of a temperature condition, a precipitation condition, and an activity type condition based on the environmental conditions and the activity information, and generate candidate clothing data for each clothing component as a higher-level clothing concept,

apply user preference information and past evaluation information to the candidate clothing data, narrow down the candidate clothing data, and generate clothing determination data suitable for the user,

generate a prompt sentence by structuring, as natural language text, description information including the environmental conditions, the activity information, the candidate clothing data, and the clothing determination data, and input the prompt sentence to a generative AI model to acquire an explanation text in natural language corresponding to the clothing determination data,

generate notification information including the clothing determination data and the explanation text, and transmit the notification information to an information processing terminal having a communication function so that the information processing terminal presents the notification information to the user,

acquire evaluation information and comment information from the user with respect to the notification information, and store, as learning data, the evaluation information and the comment information in association with the environmental conditions, the activity information, and the clothing determination data, and

update at least one of the clothing rule information and a determination parameter for generating the clothing determination data based on the learning data, and automatically adjust the candidate clothing data and the prompt sentence generated thereafter.

### (Supplementary 2)

The system according to supplementary 1,

wherein the processor is configured to

acquire the schedule data from the schedule management unit based on permission from the user, and use the schedule data as the activity information for generation of the clothing determination data.

### (Supplementary 3)

The system according to supplementary 1,

wherein the processor is configured to

transmit the notification information to the information processing terminal having the communication function, and notify the user of the clothing determination data and the explanation text via a message delivery unit or a notification control unit.

### Application Example 1

### (Supplementary 1)

A system comprising a processor,

wherein the processor is configured to

acquire user context information including at least location information and schedule information from a terminal apparatus,

acquire weather data from an external weather information providing apparatus on the basis of the location information included in the user context information, and normalize the weather data by at least time period and temperature range,

acquire the schedule information from an external schedule management apparatus and classify the schedule information into event types and clothing requirement levels,

apply a rule set that associates clothing elements with at least temperature conditions, weather conditions, and activity conditions, on the basis of the normalized weather data and the classified schedule information, and computationally determine basic clothing candidates, generate a prompt sentence on the basis of the basic clothing candidates and the user context information, the prompt sentence instructing a generative AI model to concretize a clothing proposal and provide reasoning while describing contents of the basic clothing candidates, execute an inquiry process to the generative AI model by using the generated prompt sentence and acquire, from the generative AI model, a clothing proposal and an explanation in natural language,

format the acquired clothing proposal and explanation as structured data and transmit the structured data to the terminal apparatus to present the structured data to a user, and

acquire product data from a store product information management apparatus, generate association information that associates the clothing proposal included in the structured data with actual products on the basis of the product data and the structured data, and transmit the association information to the terminal apparatus.

### (Supplementary 2)

The system according to supplementary 1,

wherein the processor is configured to acquire the schedule information from the external schedule management apparatus on the basis of permission information from the user, and adjust the prompt sentence so that the schedule information is included in the prompt sentence supplied to the generative AI model.

### (Supplementary 3)

The system according to supplementary 1,

wherein the processor is configured to cause the terminal apparatus, on the basis of the structured data and the association information, to notify, via an application having a communication function, the user of determined clothing and corresponding store products, and to transfer an additional input prompt sentence from the user to the generative AI model so that the clothing proposal is interactively updatable.

### Example 2

### (Supplementary 1)

A system comprising a processor,

wherein the processor is configured to

parse a natural language prompt sentence acquired from a user via a communication device, and extract location information, time information, event information, and preference information from the prompt sentence,

acquire weather information from an external information providing device based on the extracted location information and time information, and aggregate weather conditions in a time period corresponding to the event information to generate weather context information including temperature information and precipitation probability information,

acquire schedule information from an electronic schedule management device based on the extracted time information, and generate schedule context information including a formality level of the event and an indoor/outdoor classification based on the event information and the schedule information,

generate context data by integrating the weather context information, the schedule context information, and the prompt sentence, and generate a prompt for instructing a generative AI model to generate an outfit proposal based on the context data,

acquire outfit proposal information from the generative AI model in response to the context data, and generate outfit configuration information including clothing items, colors, and, when necessary, outerwear, based on the outfit proposal information,

acquire product information of garments from a product information providing device based on the outfit configuration information, and generate proposal message data by associating the product information with the outfit configuration information, and

transmit the proposal message data to the communication device via a communication application and notify the user of the outfit proposal.

### (Supplementary 2)

The system according to supplementary 1,

wherein the processor is configured to interpret a relative time expression in the prompt sentence as an absolute date and time based on reference time information, and determine a target acquisition period for the weather information and the schedule information using the absolute date and time.

### (Supplementary 3)

The system according to supplementary 1,

wherein the processor is configured to, when an additional prompt sentence is received from the user after the outfit proposal information is acquired from the generative AI model, reintegrate the additional prompt sentence into the context data to update the prompt, and regenerate the outfit proposal information based on the updated prompt.

### Application Example 2

### (Supplementary 1)

A system comprising a processor,

wherein the processor is configured to

analyze user voice information and user image information to identify an emotional state of a user,

generate a prompt sentence to be input to a generative information processing model, based on weather information and seasonal information acquired from an external information providing apparatus, the emotional state, user behavioral schedule information, and user attribute information,

adjust the prompt sentence so as to optimize a clothing recommendation by the generative information processing model, by adding, to the prompt sentence, conditions relating to a formality level and an activity type in accordance with contents of the behavioral schedule information,

analyze clothing recommendation information output from the generative information processing model to structure the clothing recommendation information into clothing elements and accessory elements, and associate the structured clothing recommendation information with merchandise information stored in a merchandise information storage apparatus, and

transmit the associated clothing recommendation information to a terminal apparatus via a communication function, and update contents of generation and adjustment of the prompt sentence based on evaluation information of the user acquired from the terminal apparatus.

### (Supplementary 2)

The system according to supplementary 1,

wherein the processor is configured to

acquire the behavioral schedule information from a schedule management apparatus based on authentication information of the user, and classify the behavioral schedule information into a plurality of categories including business activity, private activity, and ceremonial activity, to determine the conditions to be added to the prompt sentence.

### (Supplementary 3)

The system according to supplementary 1,

wherein the processor is configured to

transmit, via an information transmission apparatus having the communication function, the structured clothing recommendation information and the merchandise information as notification data to the terminal apparatus, and acquire the evaluation information through display and selection operations performed at the terminal apparatus.

What is claimed is:

1. A system comprising:
circuitry configured to:
receive, via a communication interface coupled to a packet-switched network, input data comprising user attribute information and environment information from a terminal device, and analyze the input data to generate a user state representation;
acquire time-referenced environment data from an external data source via the communication interface based on the user state representation and acquired time information, and generate environmental condition parameters for a target time period based on the time-referenced environment data;
acquire schedule data from a schedule management unit via the communication interface, classify scheduled items included in the schedule data into activity categories comprising activity type classifications and contextual classifications, and generate activity condition parameters from the classified schedule data;
generate a prompt sentence for instructing a generative AI model, the prompt sentence incorporating the user state representation, the environmental condition parameters, and the activity condition parameters, and input the prompt sentence to the generative AI model to obtain a configuration recommendation;
apply user preference information and past evaluation information to refine the configuration recommendation and generate structured recommendation data; and
transmit the structured recommendation data to the terminal device via the communication interface.

2. The system according to claim 1, wherein the circuitry is configured to receive audio data and image data from the terminal device, apply a voice analysis model to the audio data to extract prosodic features, apply a facial expression recognition model to the image data to generate an expression classification, and combine the prosodic features and the expression classification to generate the user state representation.

3. The system according to claim 2, wherein the circuitry is configured to apply an emotion recognition model to the combined prosodic features and expression classification to generate an emotion label and a confidence level, and incorporate the emotion label and the confidence level as conditioning parameters in the prompt sentence.

4. The system according to claim 3, wherein the circuitry is configured to receive updated audio data and image data from the terminal device and update the emotion label based on the updated data, and update the prompt sentence with the updated emotion label to generate a revised configuration recommendation.

5. The system according to claim 4, wherein the circuitry is configured to receive evaluation information from the terminal device indicating user acceptance or rejection of the configuration recommendation, and update user preference information stored in a storage device based on the evaluation information.

6. The system according to claim 1, wherein the circuitry is configured to acquire the schedule data from a schedule management unit based on authentication information of the user received from the terminal device, and classify scheduled items into a plurality of activity categories including formal activity, informal activity, and ceremonial activity.

7. The system according to claim 6, wherein the circuitry is configured to determine conditions to be added to the prompt sentence based on the classified activity categories, and adjust the prompt sentence to instruct the generative AI model to optimize the configuration recommendation for each classified activity category.

8. The system according to claim 1, wherein the circuitry is configured to refer to rule information defined for each combination of environmental condition parameters and activity condition parameters, generate candidate configuration data for each configuration component as higher-level concepts, and apply user preference information and past evaluation information to narrow down the candidate configuration data.

9. The system according to claim 8, wherein the circuitry is configured to generate the candidate configuration data using a rule-based matching function that maps environmental condition parameters and activity condition parameters to predefined configuration component categories, and apply a scoring model to rank candidates based on user preference information.

10. The system according to claim 9, wherein the circuitry is configured to apply a collaborative filtering model to past evaluation information stored in a storage device to identify preference patterns, and use the identified preference patterns to adjust the scoring model parameters.

11. The system according to claim 1, wherein the circuitry is configured to generate the structured recommendation data in a format comprising a ranked list of configuration options with associated confidence scores and explanatory text, and transmit the structured recommendation data to the terminal device via the communication interface.

12. The system according to claim 11, wherein the circuitry is configured to update the contents of the prompt sentence based on evaluation information received from the terminal device, and input the updated prompt sentence to the generative AI model to generate a refined configuration recommendation.

13. The system according to claim 1, wherein the circuitry is configured to acquire the time-referenced environment data comprising temperature data, precipitation data, and atmospheric pressure data from an external meteorological data source, and derive the environmental condition parameters by classifying the time-referenced environment data against predefined threshold ranges.

14. The system according to claim 13, wherein the circuitry is configured to apply a time-series prediction model to historical environment data stored in a storage device to generate predicted environmental condition parameters for future time periods, and incorporate the predicted environmental condition parameters in the prompt sentence.

15. The system according to claim 1, wherein the circuitry is configured to apply a natural language processing model to explanatory text included in scheduled items of the schedule data to extract contextual keywords, and use the extracted keywords to supplement the activity condition parameters.

16. The system according to claim 15, wherein the circuitry is configured to apply a named entity recognition model to the extracted contextual keywords to identify location references and participant count data, and incorporate the location references and participant count data as additional parameters in the prompt sentence.

17. The system according to claim 1, wherein the circuitry is configured to store the structured recommendation data and associated prompt sentence in a storage device indexed by user attribute information and time information, and use stored historical recommendation data to generate trend-based adjustment parameters for subsequent prompt sentence generation.

18. A system comprising:
circuitry configured to:
receive, via a communication interface coupled to a packet-switched network, audio data and image data from a terminal device, apply a voice analysis model to the audio data to extract prosodic features, and apply a facial expression recognition model to the image data to generate an expression classification;
apply an emotion recognition model to the prosodic features and the expression classification to generate an emotion label and a confidence level, acquire environmental condition parameters from an external data source, and acquire schedule data from a schedule management unit and classify scheduled items into activity categories;
generate a prompt sentence incorporating the emotion label, the confidence level, the environmental condition parameters, and activity condition parameters derived from the classified schedule data, and input the prompt sentence to a generative AI model to obtain a configuration recommendation;
apply user preference information and past evaluation information to refine the configuration recommendation and generate structured recommendation data; and
transmit the structured recommendation data to the terminal device via the communication interface, and update user preference information stored in a storage device based on evaluation information received from the terminal device.

19. The system according to claim 18, wherein the circuitry is configured to receive evaluation information from the terminal device indicating user acceptance or rejection of the configuration recommendation, update user preference information stored in the storage device, and apply a collaborative filtering model to the updated preference information to adjust scoring model parameters for subsequent configuration recommendation generation.

20. A method comprising:
receiving, via a communication interface coupled to a packet-switched network, input data comprising user attribute information and environment information from a terminal device, and analyzing the input data to generate a user state representation;
acquiring time-referenced environment data from an external data source via the communication interface based on the user state representation and acquired time information, and generating environmental condition parameters for a target time period based on the time-referenced environment data;
acquiring schedule data from a schedule management unit via the communication interface, classifying scheduled items included in the schedule data into activity categories comprising activity type classifications and contextual classifications, and generating activity condition parameters from the classified schedule data;
generating a prompt sentence for instructing a generative AI model, the prompt sentence incorporating the user state representation, the environmental condition parameters, and the activity condition parameters, and inputting the prompt sentence to the generative AI model to obtain a configuration recommendation;
applying user preference information and past evaluation information to refine the configuration recommendation and generate structured recommendation data; and
transmitting the structured recommendation data to the terminal device via the communication interface.
